(19) United States
(12) Patent Application Publication
(10) Pub. No.: US 2026/0314728 A1
(43) Pub. Date: Oct. 15, 2026

(54) Garments Including Inflatable Components

(71) Applicant: NIKE, Inc., Beaverton, OR (US)

(72) Inventors: Montserrat Ciges Lopez, Portland, OR (US); Chloe Kov, Beaverton, OR (US); Nick Galluzzo, Beaverton, OR (US); Simon Quay, Portland, OR (US)

(21) Appl. No.: 19/642,513

(22) Filed: Apr. 8, 2026

Related U.S. Application Data
(60) Provisional application No. 63/786,190, filed on Apr. 9, 2025.

(51) Int. Cl. A41D 31/06

(52) U.S. Cl. CPC A41D 31/06; A41D 2400/14

(57) ABSTRACT

Garment components include one or more fluid-filled bladder chambers. The bladder chamber(s) may be convertible between a deflated condition and an inflated condition. In at least some examples of this technology, garments and garment components may include features that enable formation of dome structures (e.g., thermoformed domes) at one or more garment surfaces. Such dome structures can help hold at least some portions of the garments and garment components off the wearer’s body, improve the comfort and/or feel (e.g., against the wearer’s body), improve breathability, and/or provide an additional volume of insulation.

### RELATED APPLICATION DATA

This application is a U.S. Non-Provisional Application and claims priority benefits based on U.S. Provisional Patent Appln. No. 63/786,190 filed Apr. 9, 2025 and entitled “Garments Including Inflatable Components.” U.S. Provisional Patent Appln. No. 63/786,190 is entirely incorporated herein by reference.

Aspects of the present technology may be used in conjunction with laminates, bladders, and/or garment components of the types described in one or more of: (a) U.S. Provisional Patent Appln. No. 63/677,693 filed Jul. 31, 2024 and entitled “Laminates, Bladders, and Garments Including Laminates and Bladders,” (b) U.S. Provisional Patent Appln. No. 63/677,708 filed Jul. 31, 2024 and entitled “Laminates, Bladders, and Garments Including Laminates and Bladders,” (c) U.S. Provisional Patent Appln. No. 63/677,842 filed Jul. 31, 2024 and entitled “Laminates, Bladders, and Garments Including Laminates and Bladders,” (d) U.S. Provisional Patent Appln. No. 63/677,870 filed Jul. 31, 2024 and entitled “Laminates, Bladders, and Garments Including Laminates and Bladders,” (e) U.S. Provisional Patent Appln. No. 63/726,392 filed Nov. 29, 2024 and entitled “Laminates, Bladders, and Garments Including Laminates and Bladders,” (f) U.S. Provisional Patent Appln. No. 63/726,394 filed Nov. 29, 2024 and entitled “Laminates, Bladders, and Garments Including Laminates and Bladders,” (g) U.S. Provisional Patent Appln. No. 63/726,399 filed Nov. 29, 2024 and entitled “Laminates, Bladders, and Garments Including Laminates and Bladders,” and (h) U.S. Provisional Patent Appln. No. 63/726,427 filed Nov. 29, 2024 and entitled “Laminates, Bladders, and Garments Including Laminates and Bladders.” Each of U.S. Provisional Patent Appln. No. 63/677,693, U.S. Provisional Patent Appln. No. 63/677,708, U.S. Provisional Patent Appln. No. 63/677,842, U.S. Provisional Patent Appln. No. 63/677,870, U.S. Provisional Patent Appln. No. 63/726,392, U.S. Provisional Patent Appln. No. 63/726,394, U.S. Provisional Patent Appln. No. 63/726,399, and U.S. Provisional Patent Appln. No. 63/726,427 is entirely incorporated herein by reference.

### FIELD OF THE INVENTION

The present invention relates to garment components and garments that include inflatable components (e.g., with laminates and bladders) and/or to methods of making and/or using such garment components and garments. In some aspects of this technology, garment components and garments will include inflatable bladder chambers configured to provide thermal insulation for the wearer.

### BACKGROUND

Conventional articles of apparel for providing warmth include garments such as jackets, vest, coats, and the like. Such garments typically are made from heavy materials, such as wool, fleece, or the like, and/or include insulation, such as down, polymeric fillers, etc. While potentially effective at keeping the wearer warm, some conventional garments of these types can restrict motion, e.g., particularly if worn during athletic activities.

Some conventional garments of these types can become heavier and/or experience reduced effectiveness, e.g., particularly when worn in wet conditions and/or when the fabric or insulation otherwise becomes damp or wet. These factors can result in decreased effectiveness of the garment, especially for wearers engaged in athletic activities.

### SUMMARY

This Summary is provided to introduce some general concepts relating to this technology in a simplified form that are further described below in the Detailed Description. This Summary is not intended to identify key features or essential features of the invention.

Aspects of this technology relate to garment components and garments that include inflatable components (e.g., garment and garment components that include laminates and bladders). In some aspects of this technology, garment components and garments will include inflatable bladder chambers configured to provide thermal insulation for the wearer.

In some examples of this technology, garments and garment components may include dome structures formed in one or more surfaces thereof. Such dome structures can help hold at least some portions of the garments and garment components off the wearer’s body. These features may improve the comfort and/or feel (e.g., against the wearer’s body), improve breathability, and/or provide an additional volume of insulation.

While aspects of this technology are described in terms of laminates, bladders made from one or more laminates, garment components and garments including one or more of such laminates and bladders, additional aspects of this technology relate to methods of making and/or using such laminates, bladders, garment components and garments.

### BRIEF DESCRIPTION OF THE DRAWINGS

The foregoing Summary, as well as the following Detailed Description, will be better understood when considered in conjunction with the accompanying drawings in which like reference numerals refer to the same or similar elements in all of the various views in which that reference number appears.

FIGS. 1A-1F illustrate various views and various features of garment components and garments in accordance with some examples of this technology.

FIGS. 2-4 illustrate portions of example garments or garment components formed from multi-layered laminate components.

FIGS. 5A-5C provide various views of garment components in accordance with some examples of this technology.

FIGS. 6A-6C provide various views schematically illustrating methods of making garment components in accordance with some examples of this technology.

FIGS. 7A and 7B illustrate additional example garment components in accordance with some examples of this technology.

FIGS. 8A and 8B illustrate other example garment components in accordance with some examples of this technology.

FIG. 9 illustrates other example garment components in accordance with some examples of this technology.

### DETAILED DESCRIPTION

In the following description of various examples of garment components and garments according to the present technology, reference is made to the accompanying drawings, which form a part hereof, and in which are shown by way of illustration various example structures and environments in which aspects of this technology may be practiced. It is to be understood that other structures and environments may be utilized and that structural and functional modifications may be made to the specifically described structures, functions, and methods without departing from the scope of the present disclosure.

This application and/or claims use the adjectives, e.g., “first,” “second,” “third,” and the like, to identify certain components and/or features relating to this technology. These adjectives are used merely for convenience, e.g., to assist in maintaining a distinction between components and/or features of a specific structure. Use of these adjectives should not be construed as requiring a specific order or arrangement of the components and/or features being discussed. Also, use of these specific adjectives in the specification for a specific structure does not require that the same adjective be used in the claims to refer to the same part (e.g., a component or feature referred to as the “third” in the specification may correspond to any numerical adjective used for that component or feature in the claims).

This application describes components (e.g., garment components (including fabric components and laminated components), bladder components, film layers, and the like) that are “bonded” together. The term “bonded” (and derivatives thereof) means that the components are joined securely to one another. The term “bonded” encompasses bonds formed using adhesives or cements (including hot melt adhesives) as well as bonds formed in an “adhesive-free” manner, i.e., without use of a separate adhesive component.

“Adhesive-free” bonds include: bonds formed by fusing or melting components together (e.g., if the components include compositions that are compatible to mix and join together to form a bond, such as two components including a thermoplastic polyurethane (“TPU”) component); bonds formed by welding techniques (e.g., RF welding, ultrasonic welding, high-frequency welding, laser welding, impulse welding, etc.); bonds formed by heat sealing (e.g., by applying heat and optionally, pressure); etc. Some adhesive-free bonds may form a seamless joint between the two previously separate components (e.g., the materials may mix and join together and then re-harden with no discernible junction).

The term “melt bond” and variations thereof, as used herein, mean bonds formed where localized melting of each component occurs (e.g., melting of the thermoplastic polymer present in each component), the melted components combine together, and then the combined components harden to thereby “fuse” and “bond” the two components together. Such melt bonded joints are adhesive-free and may be seamless.

The term “engaged with” is used herein as a generic term and includes both adhesive based bonds and adhesive-free bonds within its scope as well as other potential types of engagement that fix two (or more) components together in a “non-bonded” manner (including through the use of mechanical connectors or fasteners, through the use of sewing or stitching, etc.).

The term “fluid impervious” as used herein means that the noted component (e.g., a film, a laminated component, a bonded region, a seam, a surface, a bladder, a garment component, a garment, etc.) is capable of stopping or reducing a rate at which air passes from one side of the component to the other side of the component. “Fluid impervious” chambers, bladders, garment components, and/or garments in accordance with at least some examples of this technology will maintain an inflated condition (holding air at a pressure above atmospheric pressure) for at least 10 minutes. While some gas may leak out of or diffuse through a “fluid impervious” component over time, the component may be considered “fluid impervious” if it can maintain an inflated condition (with the contained air at a pressure above atmospheric pressure) for at least about 10 minutes.

A “dome structure,” as that term is used herein, means a structure having a circular, polygonal, elliptical, or oval base and a generally rounded closed exterior surface extending outward from that base. The generally rounded closed exterior surface of a “dome structure” may be smoothly curved, hemispherical shaped, or correspond to a section of a sphere or ellipsoid. Alternatively, in some examples, the generally rounded closed exterior surface of a “dome structure” need not be perfectly smooth, but it may have multiple planar facets, dimples, small projections, or the like, provided the overall surface provided has a generally rounded shape or generally resembles a smoothly curved “dome,” e.g., akin to a geodesic surface or a portion of a golf ball type surface.

Given the general description of features, examples, aspects, structures, and methods according to examples of this technology provided above, a more detailed description of specific example laminates, bladder structures, garment components, garments, and methods in accordance with this technology follows.

### I. Detailed Description of Example Garment Components, Garments, and Methods According to this Technology

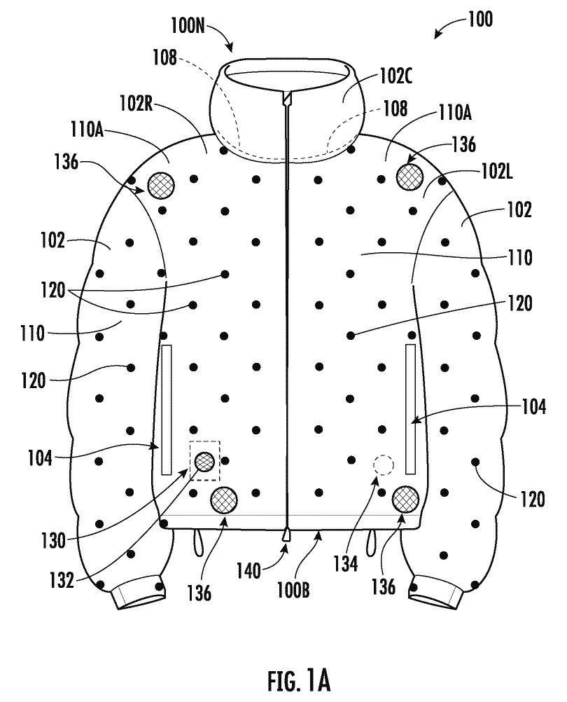

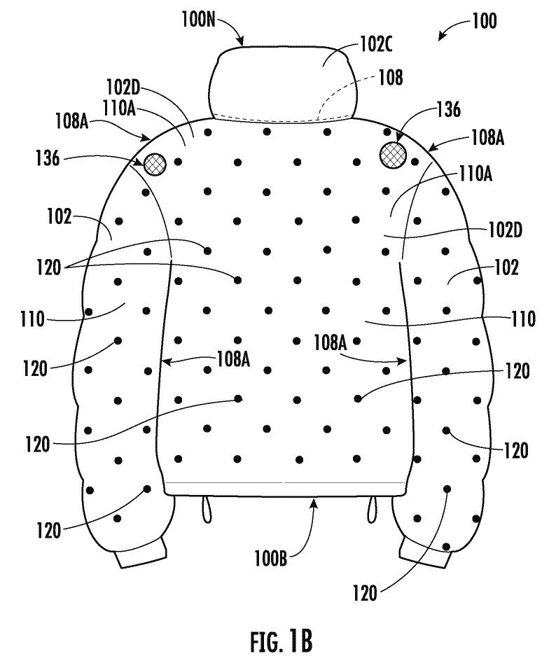

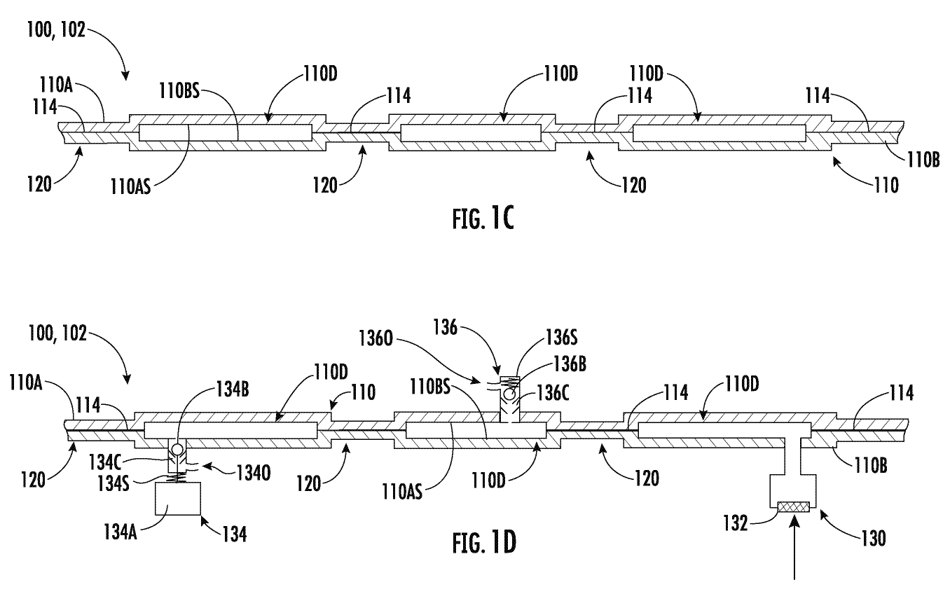

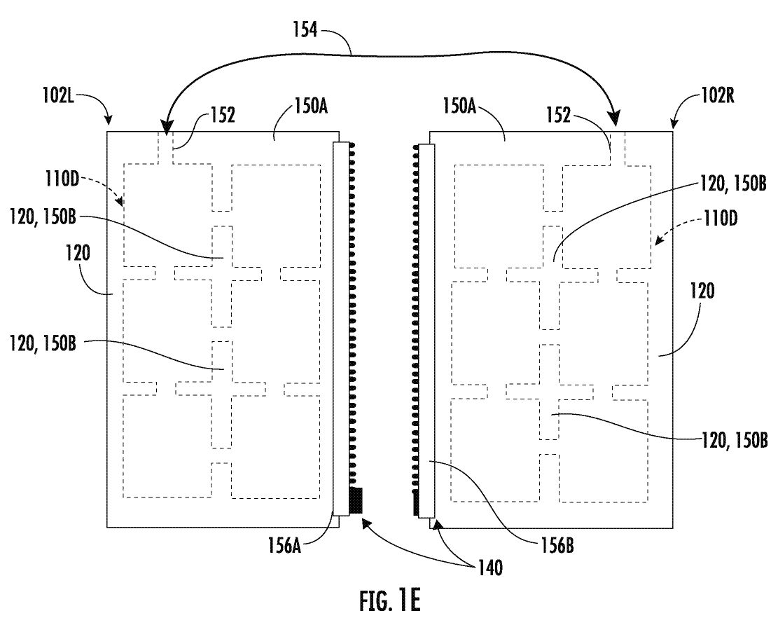

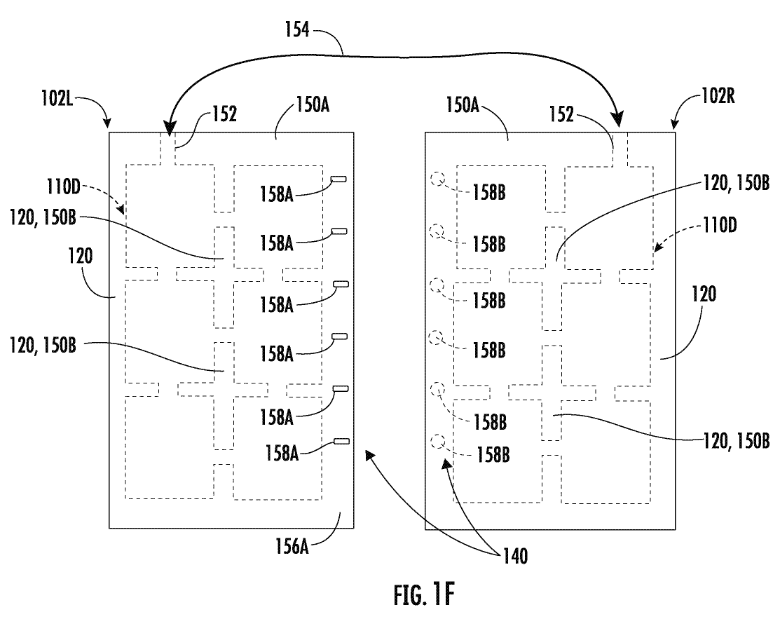

FIGS. 1A-1F show various features of garments 100 in accordance with some aspects of this technology. More specifically: FIG. 1A provides a front view of a garment 100 including one or more garment components 102 that include an inflatable bladder chamber 110 (a sealed and fluid impervious chamber configured to contain a fluid under pressure); FIG. 1B provides a back view of the garment; FIG. 1C provides a partial cross-sectional view of a bladder chamber 110 of a garment component 102 showing bonded regions 120 and inflatable chamber portions 110D; FIG. 1D provides a partial cross sectional view of a bladder chamber 110 of a garment component 102 showing other potential features; and FIGS. 1E and 1F provide views illustrating features of incorporating a securing system 140 into garments 100 according to some examples of this technology. FIGS. 1A-1F also provide information useful for understanding features of garment components that have inflatable bladder chambers that may be used in other examples of this technology.

The specific example garment 100 of FIGS. 1A and 1B is formed as a jacket or coat, but other types of garments may be formed in other specific examples of this technology, such as a jacket with a hood, a vest, a shirt, another type of upper body garment, another type of garment including an upper body portion, a lower body garment, a garment having a lower body portion, a footwear upper, etc. The garments 100 may be converted between a deflated condition (with inflatable bladder chamber 110 and bladder chamber portions 110D substantially emptied and/or flat) and an inflated condition (with inflatable bladder chamber 110 and bladder chamber portions 110D containing a gas (e.g., air) under pressure).

When in the inflated condition, garments 100 in accordance with aspects of this technology will provide increased thermal insulative properties as compared to the same garment 100 in the deflated condition.

Additionally or alternatively, garments 100 in accordance with aspects of this technology may provide different features (e.g., different color combinations, different graphic display features, etc.) when converting from a deflated configuration to an inflated configuration and/or when converting from an inflated configuration to a deflated configuration (e.g., a color or graphic reveal as a result of inflation or deflation, etc.).

In some examples, the level of inflation of a garment 100 (e.g., the volume of air introduced, the pressure of the air within the bladder chamber 110, etc.) may be varied and/or controlled. As some more specific examples, different levels of inflation of a garment 100 may correlate to different thermal resistivities associated with the garment 100 and/or different thicknesses of the layer of air provided in the bladder chamber 110D. In garments having these inflatable bladder features, a wearer may be able to control and vary the level of thermal resistivity of the garment 100.

Garments 100 in accordance with at least some aspects of this technology may be washable and reusable. The garments 100 may be formed from one or more garment components 102 that include an inflatable bladder chamber 110 or a portion thereof, as will be described in more detail below. The garments 100 may be made from different numbers of garment components 102 that include an inflatable bladder chamber 110, e.g., including from one such garment component 102 (e.g., forming a front, back, and/or sides of the garment 100) to ten or more such garment components 102. When made from multiple garment components 102 including inflatable bladder chambers 110, at least some of the inflatable bladder chambers 110 of the different garment components 102 may be interconnected and in fluid communication.

Alternatively, in some examples of this technology, when made from multiple garment components 102 that include inflatable bladder chambers 110, one or more garment component 102 having an inflatable bladder chamber 110 may be in fluid isolation from one or more other garment components 102 having an inflatable bladder chamber 110D in the overall garment 100 structure. In such garments 100, one garment component 102 may be in an inflated condition while one or more other garment components 102 is/are in a deflated condition and/or one garment component 102 may be in a deflated condition while one or more other garment components 102 is/are in an inflated condition.

Additionally or alternatively, one or more garment components 102 having inflatable bladder chambers 110 may be selectively and/or individually inflated or deflated, e.g., to allow selective control of and/or to provide increased thermal resistivity or decreased thermal resistivity at local areas of the garment 100. For example, in a garment 100 formed as a vest structure, the front and back of the vest may have separate inflatable garment components 102 that may be separately controllable, e.g., so that the front may be inflated while the back is deflated and/or so that the front is deflated while the back is inflated. As another example, in an upper body garment with sleeves (e.g., a jacket or coat), the sleeves may be separately controllable, e.g., so that the sleeves (or each individual sleeve) may be inflated while the front and/or back is deflated and/or so that the sleeves (or each individual sleeve) may be deflated while the front and/or back is inflated. Many options and alternatives may be provided for providing separately inflated and/or separately inflatable garment components in a single garment structure.

Garment components 102 that include inflatable bladder chambers 110 may be joined with garment components that do not include inflatable bladder chambers in accordance with at least some examples of this technology. Alternatively, at least one of the laminated components 110A and/or 110B may be replaced with a fluid impervious layer, such as one or more of a polyurethane layer and/or a thermoplastic polyurethane layer.

Garment components 102 that include an inflatable bladder chamber 110 may be made from two laminated components in some examples of this technology—an exterior laminated component 110A and an interior laminated component 110B. Note FIGS. 1C and 1D.

The exterior laminated component 110A and the interior laminated component 110B may be joined together in a manner so as to provide inflatable bladder chamber portions 110D and bonded regions 120. Bonded regions 120 may be provided at the exterior edge of a garment component 102 (e.g., at an outer perimeter of the garment component 102 and/or the bladder chamber 110) to form a seam and/or to provide fluid-impervious engagement between the exterior laminated component 110A and the interior laminated component 110B.

Additional bonded regions 120 may be provided at interior locations within the inflatable bladder chamber 110 (e.g., to control the bladder chamber 110’s shape and/or thickness when inflated).

Garment components 102 having the inflatable bladder chamber 110 may extend over any desired portion or proportion of the garment 100 construction. In some specific examples, the garment component 102 and/or its inflatable bladder chamber 110 may: (a) form an entire garment 100 structure; (b) form an upper body garment including at least a front portion and/or a back portion; (c) form and connect a front bladder chamber portion located in a front portion of the garment 100 and a rear bladder chamber portion located in a back portion of the garment 100; (d) extend around at least one side of the garment 100 to form and connect a front bladder chamber portion located in a front portion of the garment 100 and a rear bladder chamber portion located in a back portion of the garment 100; (e) extend over at least one shoulder region of the garment 100 to form and connect a front bladder chamber portion located in a front portion of the garment 100 and a rear bladder chamber portion located in a back portion of the garment 100; (f) form and connect one or more sleeve portions and/or sleeve bladder portions of the garment 100, e.g., connected with a front garment portion (and its bladder chamber portion) and/or a rear garment portion (and its bladder chamber portion); and/or (g) form and connect a collar or hood garment portion and/or a collar or hood bladder portion of the garment 100, e.g., connected with a front garment portion (and its bladder chamber portion) and/or a rear garment portion (and its bladder chamber portion).

At the bonded regions 120 (e.g., the outer perimeter bonded regions 120 and/or interior bonded regions 120), the facing surfaces of the exterior laminated component 110A and the interior laminated component 110B are bonded together, e.g., by an adhesive bond or in an adhesive-free manner (e.g., by a melt bond, weld bond, or fused bond). Note FIGS. 1C and 1D.

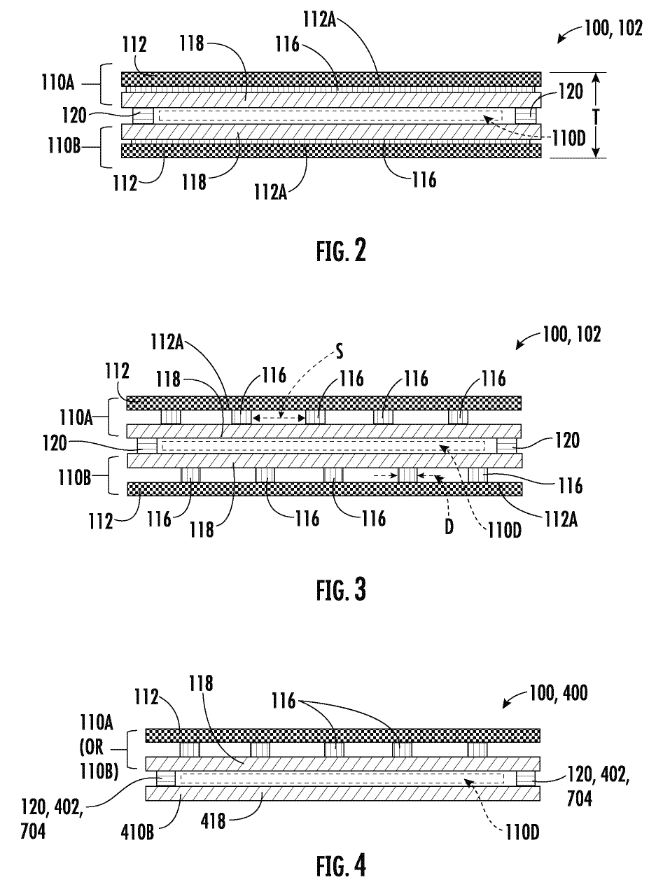

As some more specific examples, exterior laminated component 110A may be joined to interior laminated component 110B, e.g., by an adhesive provided between them at the bonded regions 120 (e.g., an adhesive bond bonding facing fabric surfaces, facing polyurethane or thermoplastic polyurethane film surfaces, other facing laminate component 110A, 110B surfaces, etc.) and/or by an adhesive-free bond (e.g., welded, melt bonded, and/or fuse bonded, for example, between facing surfaces of thermoplastic polyurethane film materials in the laminate components 110A, 110B). These interfacing surfaces are shown at reference number 114 in FIGS. 1C and 1D. In particular, the interfacing surfaces 114 may be surfaces of two film layers: (A) one comprised in the exterior laminated component 110A and the other comprised in the interior laminated component 110B, as will be described in more detail below in conjunction with FIGS. 2 and 3 or (B) one comprised in a laminated component 110A or 110B and the other comprised in a fluid impervious layer 410B, as will be described in more detail below in conjunction with FIG. 4.

At the inflatable chamber portions 110D, however, the facing surfaces of the exterior laminated component 110A and the interior laminated component 110B (or other fluid impervious layer 410B) are not bonded together such that an inflatable chamber portion 110D is defined between the facing surfaces. Note, for example, inflatable chamber portions 110D defined between surfaces 110AS and 110BS in FIGS. 1C and 1D.

FIG. 1A and 1B show bonded regions 120 at interior locations within the inflatable bladder chamber 110 of this specific example having a circular shape, with circles of substantially constant sizes arranged in staggered columns that extend from a top-to-bottom direction of the garment 100. In this illustrated example, the bonded regions 120 are evenly spaced throughout the overall garment structure 100. As shown in FIGS. 1A and 1B, the garment 100 of this example extends from a bottom opening 100B (e.g., waist opening) to a top opening 100N (e.g., neck opening) of the garment 100, and the bonded regions 120 are distributed (and may be substantially evenly distributed) around the garment 100 structure from the bottom opening 100B to the collar component 102C.

The bonded regions 120 may be provided in a wide variety of numbers, sizes, shapes, patterns, orientations, distributions, and the like, and may be present a wide variety of different aesthetic appearances. As some additional examples, the bonded regions 120 may be substantially round, square, rectangular, linear, curved, elongated, polygonal, oval, star shaped, cross shaped, or irregularly shaped in different specific examples of this technology.

In some specific examples of this technology, at least some of the individual interior bonded regions 120 may have a diameter or diagonal dimension of at least 5 mm (and in some examples, at least 6 mm or even at least 8 mm) and/or a continuous bonded area of at least 19.6 mm² (and in some examples, at least 28 mm² or even at least 50 mm²). At least 25% of the interior bonded regions 120 of a garment component 102 and/or an overall garment 100 structure may have sizes within the above ranges (and in some examples, at least 50%, at least 75%, or even at least 90% of the interior bonded regions 120 of a garment component 102 and/or an overall garment 100 structure may have sizes within the above ranges).

Further, a single garment 100 need not have all of the bonded regions 120 of the same number, size, shape, pattern, and/or orientation. The bonded regions 120 at interior locations within the bladder chamber 110 may be sized, shaped, and/or positioned to control a shape of the bladder chamber 110 (and thus a shape of the garment component 102) when it is in an inflated condition. A wide variety of bonded region 120 features are possible in various different specific examples of this technology.

FIGS. 1A and 1B show an example of a garment component 102 having an inflatable bladder chamber 110 engaged with another garment component. For example: (a) a garment component 102 that includes an inflatable bladder chamber 110 forming a front of the garment 100 may be engaged with a hood or collar member 102C that does or does not have an inflatable bladder chamber 110; (b) a garment component 102 that includes an inflatable bladder chamber 110 forming a rear of the garment 100 may be engaged with a hood or collar member 102C that does or does not have an inflatable bladder chamber 110; (c) a garment component 102 that includes an inflatable bladder chamber 110 forming a front of the garment 100 may be engaged with a side panel member that does or does not have an inflatable bladder chamber 110 (and, optionally, that same side panel member may be engaged with a rear garment component 102 that does or does not have an inflatable bladder chamber 110); (d) a garment component 102 that includes an inflatable bladder chamber 110 forming a rear of the garment 100 may be engaged with a side panel member that does or does not have an inflatable bladder chamber 110 (and, optionally, that same side panel member may be engaged with a front garment component 102 that does or does not have an inflatable bladder chamber 110); and/or (e) a garment component 102 that includes an inflatable bladder chamber 110 forming a sleeve of the garment 100 may be engaged with a panel member that does or does not have an inflatable bladder chamber 110, e.g., a panel member forming an interior region of the sleeve (and, optionally, that same panel member may be engaged with a rear garment component 102 that does or does not have an inflatable bladder chamber 110 and/or that same panel member may be engaged with a front garment component 102 that does or does not have an inflatable bladder chamber 110).

Such engagements specifically may be accomplished using a sewn seam 108, with the seam 108 stitching through the hood or collar member 102C, side panel, sleeve panel, and/or other garment component and through a portion of a bonded region 120 of garment component 102 (e.g., through a perimeter edge bonded region 120 of garment component 102). Additionally or alternatively, such engagements may be accomplished using one or more of adhesive bonding, adhesive-free bonding (e.g., formed by welding techniques, such as ultrasonic welding techniques and/or RF welding techniques), mechanical fasteners, etc.

As another example shown in FIGS. 1A and 1B, garment component 102 forming a front of the garment 100 may be engaged with another garment component that includes an inflatable bladder chamber 110, such as a garment component 102D forming a back portion of the garment 100.

Such engagements specifically may be accomplished using an adhesive bond or an adhesive-free bond (e.g., formed by welding techniques, such as ultrasonic welding techniques and/or RF welding techniques) between the garment components 102, 102D (e.g., by bonding their outer perimeter bonded regions 120 together, e.g., at shoulder seams as shown at reference number 108A in FIG. 1B and/or side seams). Additionally or alternatively, such engagements may be accomplished using one or more of a sewn seam, one or more mechanical fasteners, etc.

Additional examples and features of attaching two garment components (e.g., 102, 102D) with inflatable bladder chambers 110 are described in more detail, e.g., in U.S. Provisional Patent Appln. Nos. 63/677,693, 63/677,708, 63/677,842, 63/677,870, 63/726,392, 63/726,394, 63/726,399, and 63/726,427. FIGS. 1A and 1B further show that two garment components 102 and 102D having inflatable bladder chambers 110 may be engaged with an additional garment component (e.g., hood or collar member 102C, sleeve components 102, etc.). In this illustrated example, seam 108 extends to connect hood or collar member 102C with both the front garment component 102 and the back garment component 102D.

FIGS. 1A and 1D schematically show that this example garment 100 may include at least one pump component 130 for filling the inflatable bladder chamber 110 with air (or other desired gas). FIG. 1A shows the pump component 130 in broken lines because the pump component 130 may be located within a pocket 104 of the garment 100. The pump component 130 may be releasably attachable to fluid inlet port hardware that is fixed to one or more garment components 102 and opens into some portion of the bladder chamber 110.

If necessary or desired, an air intake 132 may be provided, e.g., defined through the pocket 104 (e.g., through garment component 102 and/or with the pump component 130), to provide air to be pumped or inserted into the inflatable bladder chamber 110.

Any desired type of pump component 130 may be provided, including a battery operated pump, a bulb type manual pump, a manually operated pump, etc. In some examples of this technology, a filter may be provided (e.g., at or with the air intake 132) to prevent dust, dirt, lint, or other undesired material from entering the pump component 130 (and thus the inflatable bladder chamber 110).

Additionally or alternatively, rather than (or in addition to) a pump 130, the garment 100’s inflatable bladder chamber 110 could be inflated by a blow tube, e.g., attached or attachable at the air intake 132 or other air input port.

FIGS. 1A and 1D also show that this example garment 100 may include at least one pressure release component 134, e.g., a pressure release valve, a closable opening (e.g., closed by a removable cap), etc., for releasing air (or other gas) from the inflatable bladder chamber 110. FIG. 1A shows the pressure release component 134 located at (e.g., within) a pocket 104 on the other side of the garment 100 from the pump component 130 (or other air input system).

If necessary or desired, at least one air outlet may be provided, e.g., defined through the pocket 104 (e.g., through garment component 102), but in some examples, the air released through the pressure release component 134 (e.g., through outlet 134O, see FIG. 1D) may be released to the interior of the pocket 104 or otherwise to the external environment.

As another example, the at least one pressure release component 134 may be provided on (e.g., mounted to) an interior layer of the garment 100 (e.g., through interior laminated component 110B), on (e.g., mounted to) an exterior layer of the garment 100 (e.g., through exterior laminated component 110A), and/or on (e.g., mounted to) layer 410B of FIG. 4.

Any desired type of pressure release component 134 may be provided, including a battery operated valve, a manually operated valve, an open outlet port covered by a removable cap, etc. The example of FIG. 1D shows a button 134A that may be pressed (against force applied by a spring 134S) to move a movable valve component (e.g., ball 134B) away from a fixed valve component (e.g., a valve seating area 134C) to open a fluid passageway through the fixed valve component to the fluid outlet 134O.

When the inflatable chamber portions 110D are inflated, the pressure of the gas within the inflatable chamber portions 110D pushes the movable valve component (e.g. ball 134B) against the fixed valve component (e.g., valve seating area 134C) to seal the pressure release valve and hold the gas within the inflatable chamber portions 110D.

Additionally or alternatively, one or more pressure release components 134 may include a valve-less pressure release structure in at least some example garment 100 structures. As a more specific example of such valve-less structures, the valve parts (e.g., valve 134B and valve seating area 134C) in one or more pressure release components 134 illustrated in FIG. 1D can be omitted and pressure release component 134 may comprise a cap that releasably secures to open and close a fluid outlet 134O, to thereby retain fluid within the bladder chamber 110 when closed and release fluid from the bladder chamber 110 when open.

Additionally or alternatively, if desired, the garment 100 may include one or more relief valves 136 at one or more locations around the garment 100 structure. The relief valves 136 may be activated to release pressure when and if pressure within the inflatable chamber portion(s) 110D exceeds a predetermined or predeterminable pressure value, e.g. becomes too high (e.g., above a “crack pressure” of the relief valve(s) 136).

Pressure may increase within the inflatable bladder portion(s) 110D at one or more local areas around the garment 100 or garment component 102, e.g., when external forces are applied to compress or flatten one or more inflatable chamber portions 110D and/or when external forces close off air access to some portion(s) of the inflatable bladder chamber 110.

For example, when a wearer sits down or falls down, some inflatable chamber portions 110D may become compressed and flattened, and the gas from those chamber portions 110D may flow into other chamber portions 110D and/or to other areas of the same chamber portion 110D. This movement of air increases the pressure of the inflatable chamber portions 110D particularly at some local areas (and may cause a significant pressure spike). One or more relief valve(s) 136 can operate to automatically open if the local pressure exceeds a predetermined or predeterminable threshold. Such relief valve(s) 136, when present, may help prevent separation of one or more interior bonded regions 120, may help prevent rupture of one or more of the inflatable chamber portions(s) 110D, and/or may help prevent breakage (e.g., bursting) of seams or seals, etc., and thereby increase the durability and life of the garment 100.

Any desired type of relief valve 136 may be provided. The example of FIG. 1D shows a relief valve 136 that includes a movable valve component (e.g., ball 136B) that is biased to seat against a fixed valve component (e.g., a valve seating area 136C) by a spring or other biasing member 136S. When fluid pressure in the local inflatable chamber portion 110D particularly exceeds the force applied to the movable valve component (e.g., ball 136B) by the biasing member 136S, the movable valve component (e.g., ball 136B) (e.g., ball 136B) moves away from the fixed valve component (e.g., valve seating area 136C) to open a fluid pathway through the relief valve 136 to the exterior environment (e.g., through valve outlet 136O).

Once the excess pressure within the local chamber portion 110D is sufficiently relieved (and/or the pressure spike has sufficiently abated), the biasing member 136S will force the movable valve component (e.g., ball 136B) back against the fixed valve component (e.g., valve seating area 136C) to again seal the relief valve 136 (and the inflatable chamber portion 110D).

FIGS. 1A, 1E, and 1F illustrate additional example features of garments 100 in accordance with at least some aspects of this technology. FIGS. 1E and 1F schematically show two garment components—e.g., a front left garment component 102L and a front right garment component 102R.

The garment components 102L and 102R particularly may have inflatable bladder chambers 110, e.g., corresponding to any of the garment components described herein, including bonded regions 120 selectively located to form (i) an outer perimeter seam 150A and (ii) one or more internal fixed regions 150B that define bladder chamber portions 110D.

In some examples of this technology, the bladder chamber portions 110D on the front left side garment component 102L may be in fluid communication with the bladder chamber portions 110D on the front right side garment component 102R, e.g., via fluid passageways 152 defined by or through the bonded regions 120 at the perimeter seam 150A. The fluid passageways 152 may connect with an inflatable bladder chamber portion 110D in a rear garment component (e.g., 102D in FIG. 1B). As another option, a fluid line may be provided to connect the fluid passageways 152 shown in FIGS. 1E and 1F (e.g., a fluid line may extend around a back component or back portion of the overall garment 100 structure). This fluid communication is shown schematically and generally in FIGS. 1E and 1F by arrow 154.

In the example of FIG. 1A, the garment 100 particularly includes a securing system 140 or a connector system, such as a zipper or other slider type fastening system. FIGS. 1E and 1F schematically illustrate some examples of manners in which securing systems 140 may be engaged with a garment 100 in accordance with aspects of this technology.

For example, as shown in FIG. 1E, this example securing system 140 includes: (a) one portion 156A engaged with or otherwise provided with the perimeter seam 150A at one edge of garment component 102L, and (b) another portion 156B engaged with or otherwise provided with an adjacent perimeter seam 150A of garment component 102R.

In some examples, each of securing system portions 156A and 156B may constitute portions of a zipper fastener or other slider fastener component. The portions 156A and 156B of securing system 140 particularly may be provided as or on strips of material (e.g., fabric) that can be attached to the garment components 102L and/or 102R by a sewn seam (e.g., through perimeter seam 150A), by an adhesive, by an adhesive free seam (e.g., a welded seam), and/or by one or more mechanical fasteners (e.g., one or more rivets or other couplings extending through perimeter seam 150A).

FIG. 1F is a view similar to FIG. 1E, but a different securing system 140 structure and engagement are shown. In the example of FIG. 1F, at least some portions of the securing system 140 may be directly formed in or provided on the garment component(s) 102L and/or 102R.

The specific example of FIG. 1F includes a button type securing system 140 in which one or more button holes 158A are formed (e.g., as through hole openings) directly through the perimeter seam 150A of one garment component (garment component 102L in this example) and one or more corresponding buttons 158B are fixed (e.g., by one or more of sewing, mechanical fasteners, adhesives, etc.) directly to the perimeter seam 150A of the other garment component (garment component 102R in this example). The one or more buttons 158B are shown in broken lines in FIG. 1F because they may be located on the other side of the surface shown in FIG. 1F. Alternatively, if desired, either the button hole(s) 158A and/or the button(s) 158B may be included with another component (e.g., such as mounted on a strip of material) that can be attached to garment component(s) 102L and/or 102R at perimeter seam 150A.

Other types of securing systems 140 may be used and attached to garments 100 and garment components 102 in manners similar to those shown in FIGS. 1E and/or 1F in other specific examples of this technology.

As some additional examples, the securing system 140 may include: (i) one or more snap type fasteners (e.g., with the snap components engaged with a flap of material attached to perimeter seam 150A or with snap components directly fixed with perimeter seam 150A); (ii) one or more buckle type fasteners (e.g., with the buckle hardware engaged with a flap of material attached to perimeter seam 150A or with the buckle hardware directly fixed with perimeter seam 150A and with the buckle strap engaged with some portion of the garment 100 (such as one of garment components 102L and/or 102R)); and/or (iii) other types of fasteners; etc.

Additionally or alternatively, the securing system 140 may comprise a belt (e.g., extending through one or more belt loops provided with one or more of the garment components 102L, 102R, etc.).

FIGS. 2 and 3 show features of laminated components 110A, 110B, bladders (including inflatable bladder chambers 110D), garment components 102, complete garments 100, and manners of making them in accordance with at least some examples of this technology. As shown, one layer of laminated components 110A, 110B constitutes a fabric 112. In other words, each one of laminated components 110A and 110B in the examples of FIGS. 2 and 3 comprises a respective fabric layer 112.

Various different types of fabrics 112 may be used in different examples of this technology. As some specific examples, fabric 112 may be an ethylene polyester (PET) material, another polyester material, a recycled polyester material, or a nylon material.

Additionally or alternatively, fabric 112 may be at least one of a layer of a knit textile, a layer of woven textile, and a layer of nonwoven textile. Still additionally or alternatively, in some specific examples, the fabric 112 may have a knit structure formed from a drawn textured yarn or a fully drawn yarn, (e.g., including a double jersey knit structure). In other examples, the fabric 112 may include a woven structure formed from a drawn textured yarn or a fully drawn yarn. Exemplarily, the fabric 112 may be a knit fabric formed from a drawn textured yarn and including a double jersey knit structure.

Additionally or alternatively, in some specific garment component 102 and/or garment 100 examples, the fabric 112 in a laminated component 110A and/or 110B may have: (a) a basis weight of at least about 15 grams per square meter (“gsm”) and less than about 150 grams per square meter; and/or (b) a linear mass density of at least about 10 denier and less than about 100 denier. As other potential ranges, the basis weight of the fabric 112 may be within a range of about 20 gsm to about 120 gsm, within a range of about 30 gsm to about 110 gsm, and/or within a range of about 35 to about 100 gsm.

Additionally or alternatively, as other potential ranges, the linear mass density of the fabric 112 may be within a range of about 12 denier to about 90 denier, within a range of about 15 denier to about 80 denier, and/or within a range of about 20 denier to about 70 denier. Still additionally or alternatively, the fabric 112 may comprise a monofilament or multi-filament polyester.

The fabric 112 may have a durable water repellant (“DWR”) (or water resistant) coating at least partly applied to it (especially any fabric 112 layer that may be exposed at the exterior of a garment 100 in a final garment 100 structure). Such a coating may be applied before the lamination process is used to apply the film 118 to the fabric 112, or the DWR coating may be applied at a later time (after lamination).

Further, the DWR material may be at least partly applied to just one surface of the fabric 112 or to both surfaces, and/or the two opposite surfaces of a fabric 112 component need not have the same amount of DWR material applied to it. The DWR material may be applied by dipping, spraying, printing, coating, and/or in other desired manners. Suitable DWR materials for fabrics are conventionally known and commercially available (e.g., fluoropolymer based materials).

For the structure shown in FIG. 2, an adhesive 116 is applied to at least some portion of a surface 112A of the fabric 112. Any desired manner of applying the adhesive 116 may be used, including spray, coating, printing, painting, etc. Also, any desired type of adhesive 116 may be used. In the example of FIG. 2, the adhesive 116 is applied as a “full” layer on the surface 112A of the fabric 112. In the “full” layer examples, the adhesive 116 layer may have a constant thickness or a varying thickness.

After the adhesive 116 is applied, a film 118 is applied to the adhesive 116 side of the adhesive infused fabric to form a laminated component, e.g., laminated component 110A and/or 110B. In the illustrated example of FIG. 2, the adhesive 116 is a “full layer” (e.g., of constant or varying thickness) covering at least 90% (and up to 100%) of the surface area between the fabric 112 and the film 118. The term “substantially continuously” (and variations thereof) as used herein in this context means that adhesive 116 is applied between a fabric 112 and a film 118 to cover at least 90% (and up to 100%) of a surface area between facing and connected surfaces of the fabric 112 and the film 118.

As described above in conjunction with FIG. 2, in some examples of this technology, the laminated components 110A and 110B are formed with a full layer of adhesive 116 (or a substantially continuous layer of adhesive 116) joining fabric 112 to film 118. In some examples of this technology, however, a full layer of adhesive 116 will not be used to form laminated components 110A and/or 110B.

FIG. 3 illustrates a fabric 112 component having adhesive 116 applied to a surface 112A thereof “discontinuously” or “intermittently,” e.g., as a plurality of spaced-apart adhesive regions disposed throughout the fabric surface 112A. The spaced-apart adhesive 116 regions may be applied to the surface 112A of the fabric 112 (or to the film 118) in any desired manner, such as by printing, by application of two-sided tape to the surface 112A or film 118, etc.

When present “intermittently” or “discontinuously,” the adhesive 116 covers less than 90% of the surface area between the fabric 112 and the film 118. In some examples of this technology, the adhesive 116 may be applied intermittently, in spaced-apart adhesive 116 regions, to cover less than 85% of an interfacing surface area between the film 118 and the fabric 112, and in some examples, less than 75%, less than 60%, less than 50%, less than 40%, or even less than 25% of this interfacing surface area. The distribution of adhesive 116 between the fabric 112 and film 118 (e.g., size, shape, and/or density of spaced-apart adhesive 116 regions) may be constant throughout the overall interfacing surface area of a laminated component 110A, 110B, or it may be varied at different regions of the overall interfacing surface area of a laminated component 110A, 110B. The “spaced-apart” adhesive 116 features can help provide a softer feel and improved drape for laminated components 110A, 110B formed from the fabric 112, adhesive 116, film 118 laminates (e.g., due to gaps between the adhesive 116 regions allowing more flexibility and producing less stiffness).

In some examples, the adhesive 116 regions will take the form of adhesive “dots,” e.g., substantially of round, oval, square, polygonal, or other desired shape(s). At least some of the spaced-apart adhesive 116 regions (or dots) may have a largest diagonal or diameter dimension D such that the spaced-apart adhesive 116 regions (e.g., dots) will be sized and shaped to contact at least 2 consecutive loops of a knit structure forming fabric 112 (and in some examples, at least 3 consecutive loops or even at least 5 consecutive loops), but particularly fewer than 10 consecutive loops of the knit structure forming fabric 112.

Specifically, the use of a drawn textured yarn with spaced-apart adhesive 116 regions of these size ranges may help the adhesive flow or sink into the knit structure to provide strong bonding and good peel strength (resistance to peeling or delamination).

Additionally or alternatively, the spaced-apart adhesive 116 regions (or dots) may be spaced from immediately adjacent neighboring adhesive 116 regions (or dots) by a spacing dimension S. Dimension D and dimension S in a specific laminated component 110A and/or 110B may be selected and balanced with respect to one another to provide a desired degree of drape or handfeel while still providing adequate peel strength. For example, smaller-sized adhesive 116 dots size (e.g., D) and/or greater adhesive 116 dot spacing (e.g., S) will tend to produce laminated components 110A, 110B having better drape and handfeel properties (as the lower amounts of adhesive 116 may tend to make the laminated component 110A, 110B feel softer and more like the base fabric 112), but the lower amount of adhesive 116 may adversely impact peel strength (and make the laminated component(s) 110A, 110B more susceptible to delamination). On the other hand, larger adhesive 116 sized dots (e.g., D) and/or smaller adhesive 116 dot spacing (e.g., S) will tend to produce laminated components 110A, 110B having excellent peel strength (and less susceptibility to delamination), but the laminated components 110A, 110B may tend to feel stiffer and have less favorable drape and handfeel properties.

The diameter or diagonal dimension D, the adhesive 116 region size ranges with respect to the number of consecutive loops, and/or the adhesive 116 region spacing dimension S described above may be present (or, in other words, apply) for at least about 25% of the spaced-apart regions of adhesive 116 in a garment 100 or garment component 102 structure, and in some examples, these ranges particularly may be present or apply for at least about 40%, at least about 50%, at least about 75%, at least about 80%, or even at least about 90% of the spaced-apart regions of adhesive 116 in a garment 100 or garment component 102 structure.

Whether using a full adhesive 116 layer (e.g., FIG. 2) or spaced-apart adhesive 116 regions (e.g., FIG. 3) between the fabric 112 and film 118 layers, laminated components 110A and/or 110B in accordance with examples of this technology may be constructed to have desired drape and/or handfeel properties. In addition to adhesive 116 dot size and/or spacings, other garment structural features particularly can impact the drape and handfeel properties, such as adhesive 116 layer thickness (e.g., for full glue examples), adhesive 116 material, fabric 112 materials, fabric 112 thickness, film 118 thickness, number of layers in the film 118, etc. As some more specific examples of this technology, a laminated component 110A and/or 110B may have drape properties that are comparable to the drape properties of the fabric 112 layer when present alone (e.g., within a threshold amount of the drape properties of the fabric 112 when present alone).

In some examples of this technology, the laminated components 110A, 110B will have a peel strength between the fabric 112 and the film 118 layer of at least about 0.85 kg/cm, and in some examples, at least about 0.9 kg/cm, at least about 0.95 kg/cm, at least about 1 kg/cm, or even at least about 1.05 kg/cm. Peel strength may be measured using International Standard ISO 2411.

FIG. 3 provides a partial cross-sectional view of a garment 100 or garment component 102 similar to the view of FIG. 2 but with an intermittent adhesive 116 layer connecting the fabric 112 and film 118 layers in both the exterior laminated component 110A and the interior laminated component 110B. The garments 100 or garment components 102 shown in FIG. 3 may be made in the same general manners as described above in conjunction with FIG. 2. Use of an intermittent adhesive 116 layer between the fabric 112 and film 118—as shown in FIG. 3—may help improve the softness, hand feel, and/or drape features of garments 100 and garment components 102 in accordance with some aspects of this technology (e.g., because less adhesive 116 is present to stiffen the laminate).

Once the laminated components 110A and 110B are formed, they may be bonded together to form garment components 102 and/or garments 100 that have fluid impervious interior bladder chambers 110D. More specifically, exterior laminated component 110A may be bonded to interior laminated component 110B using an adhesive or in an adhesive-free manner. For example, exterior laminated component 110A and interior laminated component 110B may be placed in a press so that their film 118 layers directly face one another. If needed, an adhesive may be applied between exposed and interfacing surfaces of the films 118 (e.g., to the surface of the film 118 on either or both of laminate components 110A, 110B) in a pattern to form the desired bonded regions 120 (e.g., to form an outer perimeter seam 150A and any desired interior bonded regions 120, 150B).

Additionally or alternatively, the press (e.g., its press plates) may include tooling to selectively apply force (pressure and/or heat) only at the desired bonded region 120 locations (e.g., to form an outer perimeter seam 150A and any desired interior bonded regions 120, 150B).

Then, the laminated components 110A and 110B are pressed together in the press, optionally with heating, to selectively bond the film 118 layers of the laminated components 110A and 110B together, e.g., at locations where adhesive is present and/or in an adhesive-free manner, to form the bonded regions 120 of a garment component 102 and/or garment 100. For adhesive-free bonded regions 120, the pressing force (and optionally heating, if needed) may be applied using welding techniques (e.g., RF welding, ultrasonic welding, high-frequency welding, laser welding, impulse welding, etc.); using heat sealing techniques; and/or using melt bonding techniques.

The bonded regions 120 and garment components 102 of FIGS. 2 and/or 3 may be formed in any of the ways described in any of U.S. Patent Appln. Nos. 63/677,693, 63/677,708, 63/677,842, 63/677,870, 63/726,392, 63/726,394, 63/726,399, and/or 63/726,427.

During pressing steps to form the garment components 102 of FIG. 3, the exterior laminated component 110A particularly may be exposed to somewhat different heating and/or pressing conditions than the interior laminated component 110B, e.g., depending on the starting temperature, the dwell time under pressing conditions, and/or if just one press plate 400A or 400B is heated.

Differences in the pressing conditions particularly may cause the adhesive 116 in one laminated component 110A to soften (potentially melt and/or spread out) to somewhat a different degree than that of the other laminated component 110B. Thus, even if laminated components 110A, 110B have the same structures when the bladder and/or garment fabrication process starts, they may have somewhat different structures after heating and pressing occurs.

In some examples of this technology, intermittently applied regions of adhesive 116 may be provided between the film 118 and the fabric 112 in both the exterior laminated component 110A and the interior laminated component 110B. In such structures, the intermittently applied regions of adhesive 116 need not be applied in the same pattern in the exterior laminated component 110A as the pattern in the interior laminated component 110B. For example, the exterior laminated component 110A may have a different number, size, shape, spacing, density (e.g., regions per square meter), average size, average spacing, average dispersion density, and/or arrangement of spaced-apart regions of adhesive 116 as compared to the number, size, shape, spacing, density, average size, average spacing, average dispersion density, and/or arrangement of spaced-apart regions of adhesive 116 of the interior laminated component 110B.

In particular, in some examples of this technology, the spaced-apart regions of adhesive 116 in the exterior laminated component 110A will not align with the spaced-apart regions of adhesive 116 in the interior laminated component 110B (e.g., in the vertical direction shown in FIG. 3), when the garment 100 or garment component 102 is supported on a horizontal base surface in a flat and unfolded orientation. In other words, the positions of the spaced-apart regions of adhesive 116 in the exterior laminated component 110A need not mirror the positions of the spaced-apart regions of adhesive 116 in the interior laminated component 110B.

Asymmetries between the spaced-apart regions of adhesive 116 in the exterior laminated component 110A as compared to the interior laminated component 110B particularly may help improve the hand feel and/or drape properties by potentially providing less adhesive 116 material in a direct straight line direction from the exterior-most surface to the interior-most surface of the garment component 102 (e.g., allowing the laminated components 110A, 110B to flex more easily based on the flex properties of the fabric 112 layers).

The step of fixing the film 118 to the fabric 112 (via adhesive 116) to form the laminated components 110A, 110B of FIGS. 2 and 3 specifically can take place in any desired manner, including via conventional lamination techniques, via extrusion techniques, etc. The film 118 layer (e.g., a thermoplastic elastomer layer, such as a thermoplastic polyurethane layer or a polyurethane layer) may be directly extruded onto the fabric 112.

The film 118 may be made of any desired type of material that is capable of forming fluid impervious surfaces of an inflatable bladder chamber 110. In some more specific examples of this technology, the film 118 may comprise a layer chosen from at least one of: (i) a layer of a thermoplastic polyurethane material and (ii) a layer of a polyurethane material. Additionally or alternatively, in some specific examples, the film 118 may have a multi-layered structure, e.g., with one or more layers of thermoplastic polyurethane material and/or with one or more layers of polyurethane material.

In some examples of this technology, overall film 118 (e.g., the composite of all film 118 layers present) will be less than about 150 micron thick, and in some examples, less than about 120 micron thick, less than about 100 micron thick, less than about 80 micron thick, less than about 70 micron thick, less than about 60 micron thick, or even less than about 50 micron thick. As some additional examples, film 118 may be at least about 25 micron thick (with the upper end of the range being within any of the ranges described above).

The structure depicted in FIG. 2 shows the laminated component 110A, 110B particularly formed from a film 118 that constitutes a single layer. In other examples, however, the film 118 itself may have a multi-layered construction.

As one particular example, one film 118 layer may comprise a thermoplastic polyurethane layer and the other layer of the film 118 may comprise a polyurethane layer. These two layers may be joined together (e.g., by an adhesive, by a lamination technique, by co-extrusion, by blowing techniques, etc.) to form film 118 as a composite film layer (e.g., a multi-layered film made from two materials and/or two layers).

When formed as a multi-layered film 118 including a thermoplastic polyurethane layer and a polyurethane layer, the thermoplastic polyurethane layer may face inwardly (e.g., and form the interior surface of inflatable bladder chamber 110D) and the polyurethane layer may directly face (and contact) the fabric layer 112.

As another particular example of a multi-layered film 118 structure, one layer of film 118 may comprise a thermoplastic polyurethane layer having a first melt temperature or melting point and the other layer may comprise a thermoplastic polyurethane layer having a second melt temperature or melting point, wherein the second melt temperature or melting point is higher than the first melt temperature or melting point (e.g., at least 10 degrees C. higher, and in some examples, at least 20 degrees C. higher, or even at least 30 degrees C. higher). These two layers TPU layers with different melting points may be joined together (e.g., by an adhesive, by a lamination technique, by co-extrusion, by blowing techniques, etc.) to form film 118 as a composite film layer or a multi-layer film. In such structures, the TPU layer having the higher melt temperature may be directly engaged with the fabric 112 layer and the TPU layer having the lower melt temperature may remain exposed (to form the interior surface of inflatable bladder chamber 110D). Thus, the TPU layer having the lower melt temperature may form the interior surface of a bladder chamber 110 and will be available for forming bonded regions 120 when the final garment component 102 including an inflatable bladder chamber 110D is formed.

Separating a TPU layer having a lower melt temperature from the fabric 112 with a TPU layer having a higher melt temperature may enable use of somewhat lower processing temperatures when making the bonded regions 120 of garment component 102 (e.g., when applying heat and pressure and/or when applying welding conditions (e.g., RF welding, etc.) discussed above). In at least some examples of such processing steps, the TPU layer having the higher melt temperature may maintain a stable bond to the fabric 112 while the TPU layer having the lower melt temperature bonds to a facing layer of TPU material to form the bonded region(s) 120 (e.g., perimeter seam 150A and interior bonded regions 150B).

In film 118 structures of the types shown in FIGS. 2 (and 3), the overall film 118 (e.g., the single film layer 118 or the sum of multiple layers forming a film 118) will be less than about 150 micron thick, and in some examples, less than about 120 micron thick, less than about 100 micron thick, less than about 80 micron thick, less than about 70 micron thick, less than 60 micron thick, or even less than 50 micron thick. As some additional examples, film 118 (e.g., the single film layer 118 or the sum of multiple layers forming a film 118) may be at least about 25 micron thick or even at least about 30 micron thick (with the upper end of the range being within any of the ranges described above).

In multi-layer film 118 examples, each individual film layer: (a) may be at least about 10 micron thick or even at least about 20 micron thick and less than about 100 micron thick, and in some examples, less than about 75 micron thick, less than about 60 micron thick, less than about 50 micron thick, less than about 40 micron thick, less than about 35 micron thick, less than about 30 micron thick, or even less than about 25 micron thick.

When two (or more) film layers are present in a multi-layered film 118, the individual film layers may have the same or different thicknesses (e.g., within the ranges described above). As one specific example, a two-layered film 118 of this type may have: (i) a thermoplastic polyurethane layer having a thickness of about 25 micron and (ii) a polyurethane layer or a higher melt temperature thermoplastic polyurethane layer having a thickness of about 25 micron or less. These thickness measurements may comprise thicknesses measured before lamination of film 118 to a fabric 112 layer. Lamination to the fabric 112 may result in a “compressed” or reduced thickness of the film 118 layer. In some specific examples, an initial about 50 micron film 118 layer thickness prior to lamination to fabric 112 may be compressed or reduced to a thickness of about 32 micron (total film 118 thickness) after lamination and engagement with the fabric 112.

Film 118 “compression” of this type may occur with single layer films (e.g., as shown in FIG. 2 and 3) and/or multi-layer films 118. As some specific examples, the film 118 thickness differential prior to lamination with fabric 112 v. after lamination with fabric 112 may be at least 10% smaller, and in some examples, at least 15% smaller, at least 20% smaller, at least 25% smaller, or even at least 30% smaller.

FIG. 4 illustrates a garment component 400 (which could constitute a complete garment 100) in accordance with other examples of this technology. Where the same reference number is used in FIG. 4 as used in any of FIGS. 1A-3 discussed above, the same or similar parts are being referenced, and much of the overlapping or duplicative description may be omitted.

In the example of FIG. 4, the garment component 400 includes an exterior laminated component 110A layer or an interior laminated component 110B layer that may have any of the features described above in conjunction with FIGS. 2 and 3.

An inflatable bladder chamber portion 110D (or even a complete bladder chamber 110) may be formed between: (i) the film 118 layer of the exterior laminated component 110A and (ii) a layer 410B of the garment component 400 that directly faces the film 118 layer of the exterior laminated component 110A. In this illustrated example, the layer 410B may include a film or sheet 418 having: at least one polyurethane layer and/or at least one thermoplastic polyurethane layer.

Film 418 may correspond to and/or have any of the features of films 118 described above. Alternatively, film 418 may be made somewhat thicker than the thicknesses for layer 118 described above, e.g., if necessary to provide adequate strength and durability. In some examples of this technology, layer 410B will be formed just by the film 418.

In some examples of this aspect of the present technology, the film 418 will remain exposed and will constitute an exposed surface (e.g. an interior-most layer) of the garment component 400 (and optionally an exposed surface of a garment 100 including that garment component 400). In such structures, the film 418 may be formed from a transparent, partially transparent, or translucent material, e.g., permitting visual access to at least some portions of the interior of the bladder chamber portion(s) 110D.

Additionally, while the discussion of FIG. 4 above describes film 418 as being located at the interior of the garment 100 (and the garment 100’s interior-most layer), in other examples of this technology, if desired, the film 418 may constitute an outer exterior-most surface or layer of the garment 100, and the component identified as exterior laminated component 110A in FIG. 4 may be replaced by interior laminated component 110B.

Use of a transparent, partially transparent (e.g., a colored transparent film, such as a film that is transparent to some visible light wavelengths but not all), semitransparent, or a translucent material as film 418 in the example structure of FIG. 4 provides opportunities for producing interesting designs and/or aesthetics. As some examples, adhesives 402 (forming bonded regions 120) and/or 116 may be visible through film 418. Thus, these adhesives 402 and/or 116 may be applied in different colors and/or interesting patterns that can be viewed through film 418. Additionally or alternatively, features may be provided within the bladder chamber portion 110D (e.g., provided on or with the laminated component 110A and/or 110B) that may be seen through film 418). Still additionally or alternatively, the films 418 themselves (e.g., including portions thereof) may be in different colors, e.g., to provide additional features for aesthetic designs.

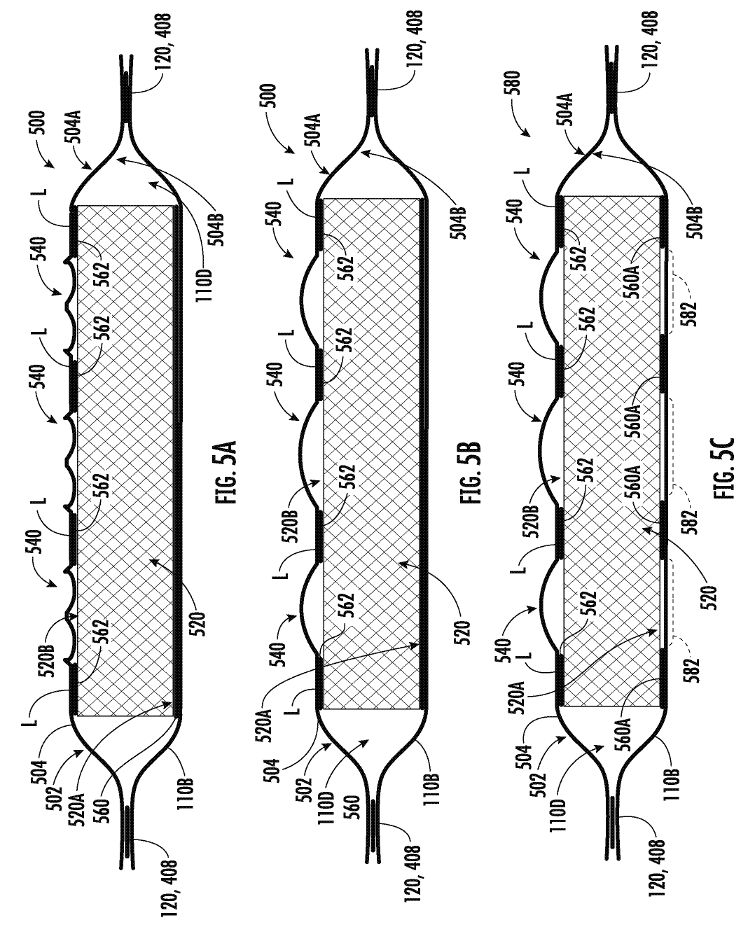

Additional aspects of the present technology will be described below in conjunction with FIGS. 5A-9. Where the same reference number is used in FIGS. 5A-9 as used in FIGS. 1A-4, the same or similar parts are being referenced, including any of the features, options, and/or alternatives for those parts, and much of the overlapping description thereof may be omitted.

FIGS. 5A and 5B provide sectional views through a portion of an example garment component 500 in accordance with some aspects of this technology. This garment component 500 may be incorporated into a garment structure, e.g., in the various manners described above in conjunction with FIGS. 1A-1F and/or in any of the manners described, for example, in any of U.S. Provisional Patent Appln. Nos. 63/677,693, 63/677,708, 63/677,842, 63/677,870, 63/726,392, 63/726,394, 63/726,399, and 63/726,427. FIG. 5A illustrates this example garment component 500 in a deflated configuration, and FIG. 5B illustrates this example garment component 500 in an inflated configuration.

This example garment component 500 includes a first laminate structure, which may correspond to laminate structures 110A and/or 110B described in more detail above. While not all of these reference numbers are shown in FIGS. 5A and 5B, as described above in conjunction with FIGS. 1A-4, the laminate structure 110B of this example may include: (i) a first fabric (e.g., fabric 112 described above) having a first inner face and a first outer face, and (ii) a first film (e.g., film 118 described above) including at least one fluid impervious layer chosen from a polyurethane layer and a thermoplastic polyurethane layer. The first film 118 may be adhesively bonded to the first inner face of the first fabric 112, e.g., in any of the manners described above in conjunction with FIGS. 1A-4.

This example garment component 500 further includes a fluid impervious component 502. The fluid impervious component 502 of this example includes a sheet component 504 having a thermoformed structure as will be described in more detail below. The sheet component 504 includes an exterior surface 504A and an interior surface 504B located opposite the exterior surface 504A. The fluid impervious component 502 is fixed with respect to the laminate structure 110B (e.g., to the first film 118 of the laminate structure 110B) at a seam 408 (e.g., which may include bonded regions 120 of the types described above, including outer perimeter bonds formed via adhesive or in an adhesive free manner). These fixed components 110B and 502 form a fluid impervious chamber 110D between laminate structure 110B (e.g., the film 118) and the interior surface 504B of the sheet component 504 of fluid impervious component 502.

The fluid impervious component 502 may be formed of various different materials and/or with various different structures, provided fluid impervious component 502 is capable of forming a thermoformed structure and capable of maintaining a fluid impervious chamber 110D. In some examples, the fluid impervious component 502 may be formed as a fluid impervious layer 410B of the types described above in conjunction with FIG. 4 (e.g., a single layer fluid impervious sheet or a multi-layered (or laminated) sheet (e.g., made from one or more of polyurethane, thermoplastic polyurethane, etc.)). Alternatively, in some examples of this technology, the fluid impervious component 502 may have a structure of the types described above for laminate structures 110A and/or 110B (e.g., a laminate with a multi-layered structure including at least a fabric 112 and a film 118 formed from one or more layers).

FIGS. 5A and 5B further illustrate that this example garment component 502 includes a fabric member 520 located between the first laminate structure 110B and the fluid impervious component 502. Thus, the fabric member 520 may be located between the first film 118 of the first laminate structure 110B and the interior surface 504B of the fluid impervious component 502 and within the fluid impervious chamber 110D. As shown, this example fabric member 520 includes: (i) a first surface 520A facing the laminate structure 110B (e.g., facing the first film 118) and (ii) a second surface 520B facing the interior surface 504B of the fluid impervious component 502.

The fabric member 520 may be formed from a fabric 112, e.g., of the types described above in conjunction with FIGS. 1A-4. In some examples, the fabric member 520 may be relatively thick (e.g., a spacer type fabric (e.g. a spacer mesh), a foam material, or other fabric, e.g., at least 1.5 mm thick) or relatively thin (e.g., as a thin sheet, e.g., less than 1 mm thick). In accordance with aspects of this technology, the fabric member 520 will be fluid permeable such that fluid (e.g., gas, such as air) can pass through and/or into the fabric member 520. Thus, fabric member 520 allows fluid to move within the inflatable bladder chamber 110D (and into, out of, and/or between the dome structures 540 that will be described in more detail below). The first surface 520A of the fabric member 520 may be bonded to the inner surface (e.g., film 118) of the first laminate structure 110B, e.g., using an adhesive bond (shown by adhesive material 560 in FIGS. 5A and 5B) or in an adhesive free manner. The material of the fabric member 520 may itself be fluid permeable. Additionally or alternatively, if desired, one or more through hole openings may be provided in the fabric member 520, e.g., to produce and/or increase fluid permeability thereof.

As further shown in FIGS. 5A and 5B, this example garment component 500 includes dome structures 540, at least when in the inflated condition. FIG. 5B shows the dome structures 540 with the garment component 500 in the inflated condition, and FIG. 5A shows the material of the dome structures 540 collapsed when this example garment component 500 is in the deflated condition. In other examples of this technology, however, the dome structures 540 could maintain their shape (or at least substantially maintain their shape) even in the deflated condition (e.g., if the material of the fluid impervious layer 502 is capable of maintaining its shape after the thermoforming process without an internal gas under pressure in the inflatable chamber 110D).

To form the dome structures 540 in this illustrated example, the second surface 520B of the fabric member 520 is bonded to interior surface 504B of the fluid impervious component 502 at locations not corresponding to the domed structures 540. Note the spaced apart adhesive regions 562 shown in FIGS. 5A and 5B. Thus, at the dome structures 540, the fabric member 520 is not bonded to the fluid impervious component 502, which allows the material of the fluid impervious component 502 to extend outward when a gas under pressure is provided in the inflatable bladder chamber 110D (i.e., when the inflatable bladder chamber 110D is in the inflated condition).

As shown in FIGS. 5A and 5B, in this illustrated example, the surface 520B of the fabric member 520 is bonded to the interior surface 504B of the sheet component 504 of the fluid impervious member 502 at a base level L of the sheet component 504. In other words, the bonds between the surface 520B of the fabric member 520 and the interior surface 504B of the sheet component 504 of the fluid impervious member 502 define a “base level” for the sheet component 504. Due to the spaced apart adhesive 562 and the unbonded regions at the dome structures 540, the thermoformed dome structures 540 extend outward and away from the base level L, at least when the garment component 500 is in the inflated condition. See FIG. 5B. As noted above, in at least some examples, the dome structure(s) 540 may remain outward from the base level L even when the garment component 500 is in the deflated condition.

FIG. 5C illustrates an alternative garment component 580 structure in accordance with some aspects of this technology. Where the same reference number is used in FIG. 5C as used in FIGS. 5A and 5B (and/or the other figures), the same part is being referenced (with any of the features, options, and/or alternatives for that part), and much of the overlapping description may be omitted. The discussion below primarily focuses on differences between the garment component 580 of FIG. 5C and the garment component 500 illustrated in FIGS. 5A and 5B.

One difference relates to the bonding between the first surface 520A of the fabric member 520 and the inner surface (e.g., film 118) of the first laminate structure 110B. The example garment component 500 of FIGS. 5A and 5B included a full bond (e.g., a full adhesive bond 560) between these interfacing surfaces. In the example garment component 580 of FIG. 5C, this bonding (e.g., using an adhesive bond or in an adhesive free manner) includes discrete, spaced apart bonded regions. This is shown in FIG. 5C by spaced apart adhesive material 560A regions (although, as noted above, adhesive free bonding also could be provided).

When bonded via spaced apart bonded regions, the bonded regions between the first surface 520A of the fabric member 520 and the inner surface (e.g., film 118) of the first laminate structure 110B (e.g., between spaced apart adhesive material 560A regions) may match up with (e.g., in size, shape, relative positioning) and/or align with the spaced apart bonded regions 562 between the second surface 520B of the fabric member 520 and the interior surface 504B of the fluid impervious component 502. Alternatively, the spaced apart bonded regions of adhesive 560A on one surface may differ from the spaced apart bonded regions of adhesive 562 on the opposite surface of the fabric member 520, e.g., in one or more of: number of bonded regions; sizes of one or more bonded regions; shapes of one or more bonded regions; areas of one or more bonded regions; relative positioning of one or more bonded regions; etc.

Further, in the example garment component 580 of FIG. 5C, when in the inflated condition, the laminate component 110B may bulge outward at locations between the spaced apart bonded regions of adhesive 560A (e.g., this bulge 582 is shown by the broken lines at the bottom of FIG. 5C), e.g., depending on the thickness, stiffness, stretchability, and/or flexibility of the laminate component 110B. But because the laminated structure 110B in this example garment component 580 is not thermoformed, in this illustrated example, the outward bulge 582 is not as pronounced as the dome structures 540 on the opposite side.

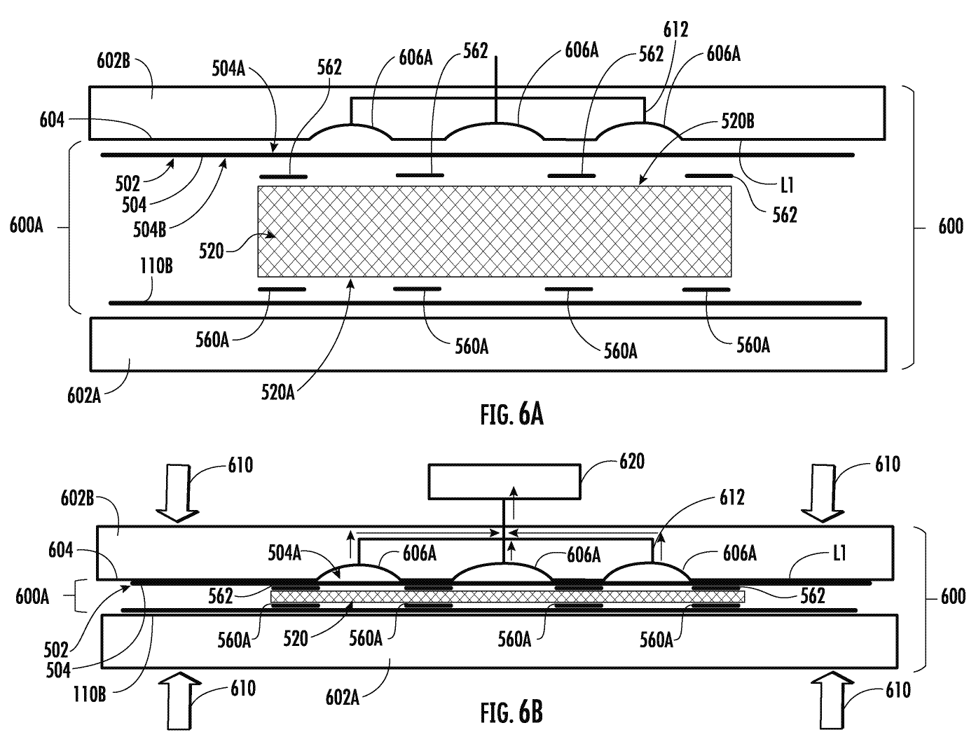

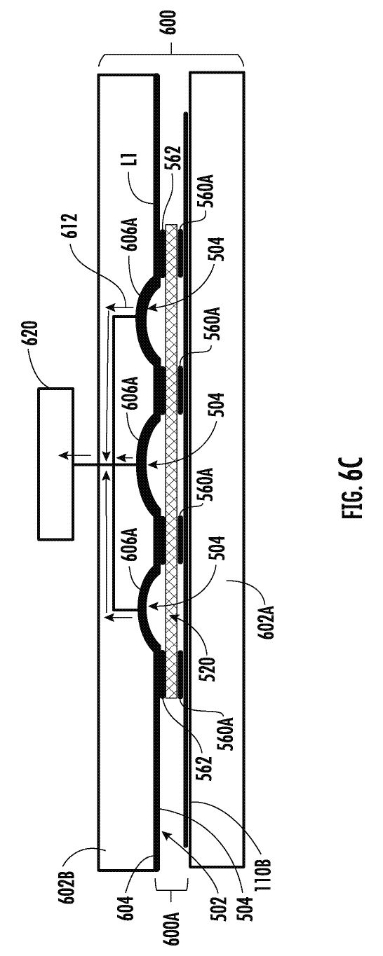

Methods of making garment components 500, 580 of the types described above will be described in more detail in conjunction with FIGS. 6A-6C. Where the same reference number is used in FIGS. 6A-6C as used in FIGS. 5A-5C (and/or the other figures), the same part is being referenced (with any of the features, options, and/or alternatives for that part), and much of the overlapping description may be omitted.

In this example method, a first laminate structure 110B is placed in a mold cavity 600A of mold 600. The mold cavity 600A in the example of FIGS. 6A-6C corresponds to the space between mold plate 602A and mold plate 602B. The first laminate structure 110B may have the features described for laminate structures 110A and/or 110B discussed above. The first laminate 110B is placed in the mold cavity 600A such that the fabric 112 of the laminate structure 110B faces the mold plate 602A.

As shown in FIGS. 6A-6C, at least one surface 604 of the mold cavity 600A (the surface 604 of mold plate 602B in the illustrated example) includes at least one recess 606A extending outward from a base level L1 of the surface 604 of the mold cavity 600A (e.g., the base level defined by mold plate 602B). Three such recesses 606A are shown in the specific example of FIGS. 6A-6C.

A fluid impervious component 502 also is placed in the mold cavity 600A. As shown in FIG. 6A, the fluid impervious component 502 is placed adjacent and facing surface 604 of the mold cavity 600A (of mold plate 602B) such that the exterior surface 504A of the fluid impervious component 502 faces the surface 604 of mold plate 602B. The fluid impervious component 502 may have the features described above for fluid impervious component 502.

Additionally, in this method, a fabric member 520 (e.g., a spacer fabric (such as a spacer mesh), foam material, etc.) is placed in the mold cavity 600A between the laminate structure 110B and the fluid impervious component 502 (e.g., between the first film 118 of the laminate structure 110B and the interior surface 504B of the fluid impervious component 502). As shown in FIG. 6A, the fabric member 520 is placed in the mold cavity 600A such that surface 520A of the fabric member 520 faces the laminate structure 110B (e.g., the film 118 thereof) and surface 520B of the fabric member 520 faces the fluid impervious member 502 (e.g., the interior surface 504B thereof).

Additionally, an adhesive may be applied between: (i) interfacing surfaces of fabric member 520 (the first surface 520A thereof) and the laminate structure 110B (film 118 thereof) and/or (ii) interfacing surfaces of fabric member 520 (the second surface 520B thereof) and the fluid impervious component 502 (the interior surface 504B thereof). FIG. 6A shows adhesive 560A between the interfacing surfaces of fabric member 520 (the first surface 520A thereof) and the laminate structure 110B (film 118 thereof) provided at spaced apart regions, as described above in conjunction with FIG. 5C. Alternatively, a full layer of adhesive 560 may be used, as described above in conjunction with FIGS. 5A and 5B.

Also, in this illustrated example, adhesive 562 between the interfacing surfaces of fabric member 520 (the second surface 520B thereof) and the fluid impervious component 502 (the interior surface 504B thereof) is provided at spaced apart regions, as described above in conjunction with FIGS. 5A and 5B. The spaced apart regions of adhesive 562 are provided such that one or more areas between the interfacing surfaces of fabric member 520 (the second surface 520B thereof) and the fluid impervious component 502 (the interior surface 504B thereof) remain free of the adhesive. As shown in FIGS. 6A and 6B, these adhesive free area(s) are located adjacent the recess(es) 606A in the surface 604 of the mold plate 602B.

The adhesive for regions 560, 560A, and/or 562 may be provided in a variety of ways in different specific examples of this technology. For example, the adhesive(s) 560, 560A, 562 may comprise a two sided adhesive tape applied to one or more of the fabric member 520 (e.g., to surface 520A and/or 520B), the laminate structure 110B (e.g., to film 118 thereof), and/or the fluid impervious component 502 (e.g., to surface 504B thereof). Additionally or alternatively, the adhesive(s) 560, 560A, 562 may be provided by applying it to one or more of the surfaces above by coating, spraying, printing, and/or other application techniques. Still additionally or alternatively, the adhesive(s) 560, 560A, 562 may be provided as a sheet of adhesive material (e.g., a sheet of hot melt adhesive) placed between: (i) interfacing surfaces of fabric member 520 (the first surface 520A thereof) and the laminate structure 110B (film 118 thereof) and/or (ii) interfacing surfaces of fabric member 520 (the second surface 520B thereof) and the fluid impervious component 502 (the interior surface 504B thereof). When provided as one or more sheets of adhesive material, the sheet(s) may include cut outs, e.g., at locations for the recess(es) 606A in the surface 604 of the mold plate 602B and/or at locations for spaces between adhesive regions 560A and/or 562.

The components 110B, 502, 520, 560, 560A, and/or 562 may be placed in the mold cavity 600A in any order, individually, and/or in any combination. In some examples of this technology, all of the components 110B, 502, 520, 560, 560A, and/or 562 may be assembled together outside of the mold cavity (e.g., as a “stack”) and then that “stack” may be inserted into the mold cavity 600A as a single unit.

Once the necessary components are provided in the mold cavity 600A, the mold 600 may be closed, e.g., as shown schematically in FIG. 6B (by arrows 610) and heat may be applied, if needed, to soften the fluid impervious component and/or the laminate structure 110B for the molding process. As shown in FIGS. 6A-6C, the mold 600 of this example includes vacuum lines 612 that open into the recess(es) 606A and are connectable with a vacuum source 620. When the vacuum source 620 is activated, negative pressure is produced between the recess(es) 606A and the exterior surface 504A of the fluid impervious component 502. This negative vacuum pressure pulls the material of the fluid impervious member 502 upward into the recess(es) 606A, as shown by a comparison of FIGS. 6B and 6C. These actions mold (e.g., thermoform) the material of the fluid impervious component 502 to form the dome component(s) 540 shown in FIGS. 5A-5C.

The material of fluid impervious component 502 may stretch or expand as a result of the vacuum force applied during the molding process to form to the shape of the recesses 606A. In some examples, the dome shapes may remain after the vacuum pressure is relaxed or removed, e.g., if the fluid impervious component 502 is formed from (or includes) a thermoformable material.

In other examples, the dome structures 540 may collapse after the vacuum pressure is removed or relaxed (e.g., as shown in FIG. 5A), and then re-expand to the dome shapes when the bladder chamber 110D is filled with gas under pressure. In such structures, the dome structures 540 may be “pre-molded” into the fluid impervious component and/or the material of the dome structures 540 may be “pre-stretched at the dome areas,” e.g., as a result of the molding process, so that the dome structures 540 can be easily re-formed, re-stretched, and/or re-inflated when the garment component is inflated during use.

Additionally or alternatively, in at least some examples of this technology, such as for dome structures 540 that have collapsible surfaces, the opacity and/or other light transmissive properties of the garment component may change between the inflated configuration and/or deflated configuration. For example, in garment components with dome structures 540 made from transparent, partially transparent, or translucent materials, the material at the dome structures 540 may become less opaque or more visible light transmissive in the inflated condition as compared to the deflated condition (e.g., as the dome structure(s) 540 re-inflate or re-stretch). Additionally or alternatively, graphics, structures, and/or components within the inflatable bladder chamber(s) 110 may become more visible through the dome structure(s) 540 in the inflated condition versus the deflated condition (e.g., providing a “reveal” of such graphics, structures, and/or components when the garment is inflated).

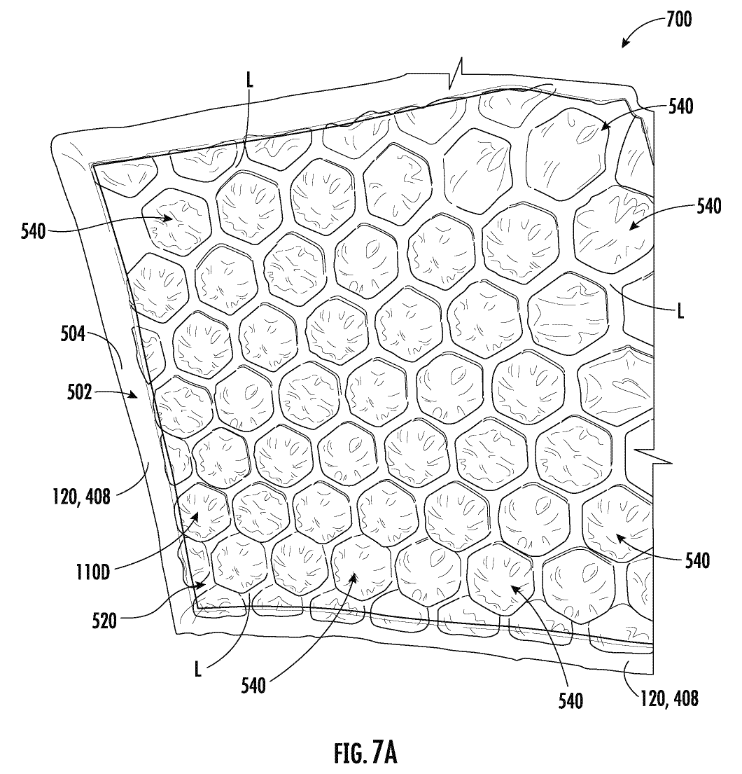

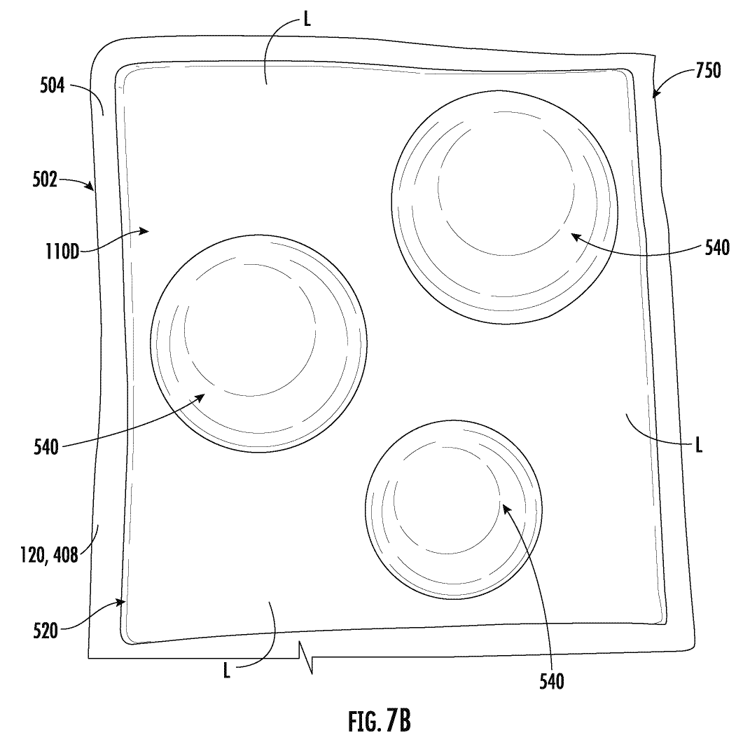

FIGS. 7A and 7B illustrate example garment components 700, 750, respectively, that include features of the types described above in conjunction with FIGS. 5A-5C and/or may be made by the methods described above in conjunction with FIGS. 6A-6C. Where the same reference number is used in FIGS. 7A and/or 7B as used in FIGS. 5A-6C described above, the same or similar parts are being referenced (including all of the features, variations, options, and/or alternatives described herein for that part), and much of the overlapping description may be omitted.

FIG. 7A shows the garment component 700 having a number of dome structures 540 formed therein. At the base level L (e.g., at the open perimeters entering the dome structures 540), the dome structures 540 of this example are hexagonal shaped (e.g., having a hexagonal perimeter). The material forming the dome structures 540 extends outward from the base level L of the fluid impervious component 502. These dome structures 540 of FIG. 7A are arranged in rows, e.g., staggered rows of dome structures 540 extending across the garment component 700. Additionally, the dome structures 540 shown in FIG. 7A all have substantially the same size and shape (except for dome structures 540 located at an outer edge of the garment component 700) and are consistently spaced apart from one another. The dome structures 540 in the example of FIG. 7A cover a majority (e.g., at least 50%) of the surface area of the fluid impervious component 502. In some examples, dome structures 540 may cover at least 60%, at least 75%, at least 80%, or at least 90% of the surface area of the fluid impervious component 502.

FIG. 7B, on the other hand, shows a garment component 750 having fewer dome structures 540. These dome structures 540, however, are quite large as compared to those of FIG. 7A. Additionally, the dome structures 540 of FIG. 7B have a circular open perimeter leading into the dome structure 540. The example of FIG. 7B further illustrates that the dome structures 540 in this garment component 750 have different sizes and are arranged in a non-regular pattern and/or spacing.

Thus, FIGS. 7A and 7B illustrate that the dome structures 540 in different specific examples of this technology may vary widely within a single garment component and/or from one garment component to another. Many other variations in the size, shapes, numbers, relative positioning, and the like could be provided for the dome structures 540 in different specific examples of this technology. For example, the open perimeter(s) of the dome structures 540 at the base level L may be formed as other polygons (e.g., triangles, squares, rectangles, trapezoid, quadrilaterals, pentagons, octagons, etc.); as ovals; as ellipses; as star shapes; as irregular shapes; etc. More or fewer dome structures 540 may be provided in a garment component, and/or the relative positioning of the dome structures 540 may vary within a single garment component. The dome structure 540 sizes, shapes, and/or spacing may be controlled, for example, based on the placement of adhesive material at the regions 562 of adhesive material used between the dome structures 540 and/or based on the size, shape, and/or positioning of recess(es) 606A in the mold 600.

The dome structures 540 may vary significantly in size, e.g., both in perimeter opening size and/or in height (extending outward from the base level L). As some more specific examples, some dome structures 540 may be relatively small, e.g., having a perimeter opening area of less than 200 mm², and in some examples, less than 150 mm², less than 100 mm², less than 75 mm², or less than 50 mm². At least some other dome structures 540, however, may be larger, e.g., having a perimeter opening area of at least 200 mm², and in some examples, at least 400 mm², at least 600 mm², at least 800 mm², or at least 1000 mm². Additionally or alternatively, at least some dome structures 540 may have a relatively short height extending away from the base level L, such as less than 40 mm, and in some examples, less than 25 mm, less than 20 mm, or less than 16 mm. Additionally or alternatively, at least some dome structures 540 may have a greater height dimension extending away from the base level L, such as at least 40 mm, at least 50 mm, at least 75 mm, or at least 100 mm. Thus, a wide variation in dome structure 540 sizes are possible in various specific examples of this technology.

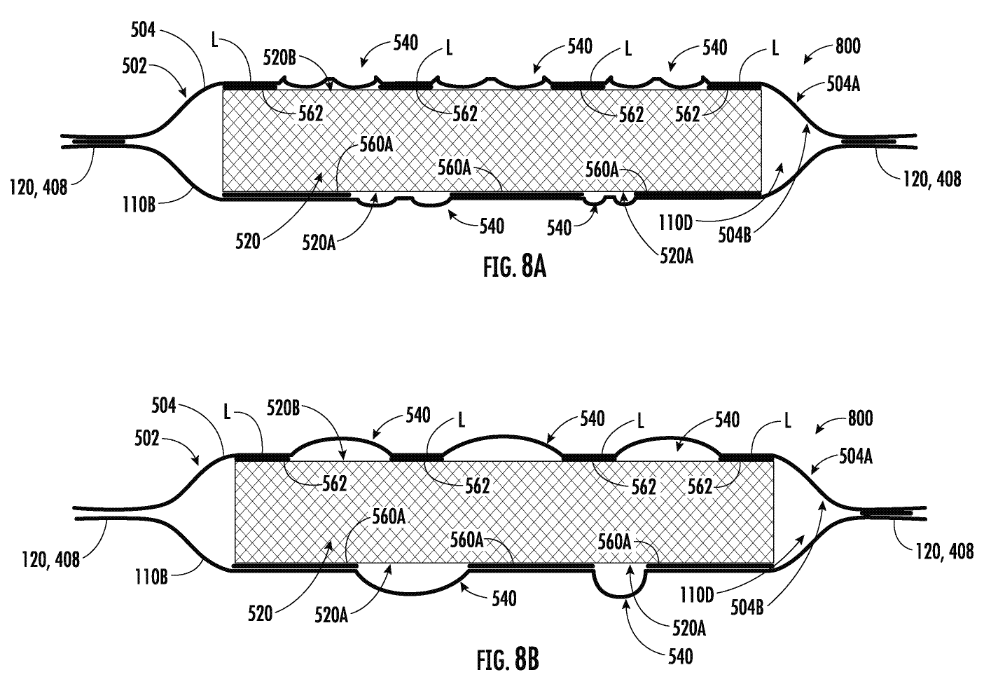

The example garment components 500, 580, 700, and 750 described above include the thermoformed dome structures 540 on one surface of those garment components. In some examples of this technology, however, two surfaces of a garment component may include such dome structures. FIGS. 8A and 8B illustrate one example. Where the same reference number is used in FIGS. 8A and/or 8B as used in FIGS. 5A-7B described above, the same or similar parts are being referenced (including all of the features, variations, options, and/or alternatives described herein for that part), and much of the overlapping description may be omitted. Much of the discussion below will focus on differences between the garment component 800 of FIGS. 8A and 8B and those discussed above.

FIGS. 8A and 8B provide sectional views through a portion of an example garment component 800 in accordance with some aspects of this technology—views similar to those discussed above for FIGS. 5A and 5B. This garment component 800 may be incorporated into a garment structure, e.g., in the various manners described above in conjunction with FIGS. 1A-1F and/or in any of the manners described, for example, in any of U.S. Provisional Patent Appln. Nos. 63/677,693, 63/677,708, 63/677,842, 63/677,870, 63/726,392, 63/726,394, 63/726,399, and 63/726,427. FIG. 8A illustrates this example garment component 800 in a deflated configuration, and FIG. 8B illustrates this example garment component 800 in an inflated configuration.

In the example of FIGS. 8A and 8B, similar to the structure shown in FIG. 5C, spaced apart regions of adhesive material 560A are provided between the first surface 520A of the fabric member 520 and the inner surface (e.g., film 118) of the first laminate structure 110B. In the example of FIGS. 8A and 8B, the garment component 800 may be made using a mold in which the mold plate 602A also includes recesses, vacuum lines, and connection to a vacuum source, e.g., akin to the recesses 606A, vacuum lines 612, and vacuum source 620 shown for mold plate 602B in FIGS. 6A-6C. In other words, to form the garment component 800 of FIGS. 8A and 8B, thermoforming will be applied to both the laminate structure 110B and the fluid impervious member 502 to produce thermoformed dome structures 540 in the surfaces of both components (i.e., in the surface of the laminate structure 110B and in the surface of the fluid impervious member 502). Alternatively, in some examples, in the arrangement of FIGS. 8A and 8B, the laminate structure 110B could be replaced with another fluid impervious material, e.g., any of the materials as described above from fluid impervious component 502.

As further shown in FIGS. 8A and 8B, this example garment component 800 includes the dome structures 540, at least when in the inflated condition. FIG. 8B shows the dome structures 540 with the garment component 800 in the inflated condition, and FIG. 8A shows the material of the dome structures 540 collapsed when the garment component 800 is in the deflated condition. In other examples of this technology, however, at least some (or all) the dome structures 540 on either or both surfaces could maintain their shape even in the deflated condition (e.g., if the material of the laminate structure 110B and/or the material of the fluid impervious layer 502 is/are capable of maintaining their shape after the thermoforming process without fluid pressure in inflatable chamber 110D).

The example garment components described above included adhesive material 560A, 562 selectively provided at locations between interfacing surfaces where bonding was desired (e.g., in spaced apart regions as described above) and no adhesive was provided at the locations where the thermoformed dome structures 540 were desired. For some materials (e.g., thermoplastic polyurethane materials), adhesive free bonds may be formed (or potentially may be formed) under at least some pressing conditions (e.g., with application of heat and/or pressure to interfacing surfaces). If the interfacing surfaces of two components to be pressed together during a molding or other processing step are capable (or potentially capable) of forming adhesive free bonds, other structures and/or steps may be used to produce the dome structures 540 in accordance with some examples of this technology.

For example, as noted above: (i) the interior surface 504B of fluid impervious member 502 may be selectively bonded to the surface 520B of fabric member 520 to produce one or more dome structures 540 at one or more locations between the bonded areas, and/or (ii) the inner surface of the laminate structure 110B (e.g., film 118) may be selectively bonded to the surface 520A of fabric member 520 to produce one or more dome structures 540 at one or more locations between the bonded areas. But, if surfaces 504B and 520B are capable of forming adhesive free bonds under the processing conditions (e.g., the molding/thermoforming conditions) and/or if the inner surface of the laminate structure 110B (e.g., film 118) and surface 520A are capable of forming adhesive free bonds under the processing conditions (e.g., the molding/thermoforming conditions), the above structures and/or methods may not produce the desired dome structures (because bonding may undesirably occur between the interfacing surfaces at the locations where dome structures 540 are to be formed).

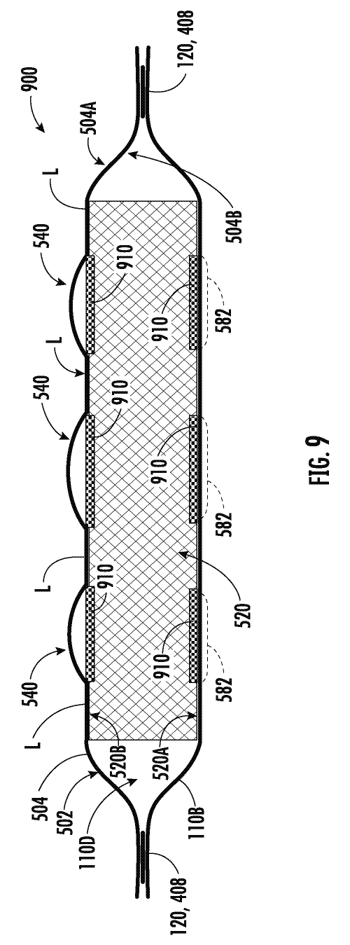

FIG. 9 illustrates an example garment component 900 structure that can allow formation of dome structures 540 between surfaces where adhesive free bonding may occur. FIG. 9 shows a view similar to that of FIG. 5C. Where the same reference number is used in FIG. 9 as used in FIGS. 5A-8B described above, the same or similar parts are being referenced (including all of the features, variations, options, and/or alternatives described herein for that part), and much of the overlapping description may be omitted. Much of the discussion below will focus on differences between the garment component 900 of FIG. 9 and those discussed above.

In the garment component 900 of FIG. 9, an adhesion blocker 910 is provided at the locations where dome structures 540 are desired. The adhesion blocker 910 may be provided in the mold 600 in the same general manner that the adhesive regions 560, 560A, and/or 562 are provided as described above in conjunction with FIGS. 6A-6C. When the mold 600 is closed and the thermoforming conditions (e.g., heat and pressure) are applied, the adhesion blocker(s) 910 will prevent bonding from occurring at the adhesion blocker 910 locations, allowing the thermoforming process to be completed and allowing the dome structures 540 to be formed.

While the example of FIG. 9 shows the adhesion blocker(s) 910 (e.g., spaced part adhesion blockers 910) being used in place of adhesive 560 and/or spaced apart adhesive regions 560A and/or 562, adhesion blocker(s) 910 may be used along with adhesive 560 and/or spaced apart adhesive regions 560A and/or 562, e.g., if additional adhesive is needed to assure a reliable bond is formed at the desired bonded region(s).

The adhesion blocker(s) 910 may include any material that will inhibit adhesive free bonding between the interfacing surfaces. Examples include ink, fabric material (e.g., such as fabric 112 described above), one sided tape, plastics, etc.

Additionally or alternatively, while the example of FIG. 9 shows adhesion blockers 910 at the interfacing surfaces of the laminate structure 110B and the fabric member 520 (surface 520A) to thereby produce the bulge 582, one or more (or even all) of those adhesion blockers could be omitted in other specific examples of this technology.

Also, while the example of FIG. 9 shows a garment component structure 900 in which the thermoformed dome structures 540 are provided only on one side of the garment component 900 (the side formed by fluid impervious member 502), adhesion blockers 910 also could be used to form dome structures 540 on two sides of a garment component, e.g., of the type shown in FIGS. 8A and 8B.

As another alternative structure in accordance with some examples of this technology, one or more dome structures 540 may be provided only on the side of the garment component including the first laminate structure 110B. As a more specific example, in the garment component 800 illustrated in FIGS. 8A and 8B, the dome structures 540 formed between interior surface 504B and fabric surface 520B may be omitted from a garment structure 800 and dome structures 540 may be provided only in laminate structure 110B (e.g., between the film 118 surface thereof and the surface 520A of fabric member 520). In such structures where one or more dome structures 540 may be provided only on the side of the garment component including the first laminate structure 110B, the side of the garment component including fluid impervious member 502 may include one or more bulge regions akin to bulges 582 shown in FIGS. 5C and 9.

Also, while this technology has been described using vacuum thermoforming as the production method (e.g., in conjunction with FIGS. 6A-6C), other types of molding and/or thermoforming processes may be used in other specific examples of this technology. As another example, positive pressure thermoforming could be used (e.g., using positive air pressure within the mold cavity 600A to push the material of fluid impervious member 502 and/or laminate structure 110B into recess(es) 606A to form the dome structures 540. Other molding techniques also may be used.

As another alternative in accordance with some examples of this technology, the laminate structure 110B in the structures of FIGS. 5A-9 may be replaced with another fluid impervious component, e.g., of the types described above in conjunction fluid impervious component 502 shown in FIGS. 5A-9. In other words, in some examples of this technology, a fluid impervious component 502 can form each side of the garment component and each side of the inflatable bladder chamber 110D. Such fluid impervious components on each side may have structures of the types described above in conjunction with fluid impervious component 410B shown in FIG. 4 (e.g., a single layer fluid impervious sheet or a multi-layered (or laminated) sheet).

The dome structures 504 described above may be provided on either or both surfaces of an overall garment or garment component. In other words, the dome structures 504 may be provided (i) on a garment component surface located closer to and facing the wearer’s body (e.g., on the garment’s interior) and/or (ii) on a garment component surface located further from and facing away from the wearer’s body (e.g., on the garment’s exterior).

Garment components 500, 580, 700, 750, 800, and 900 of the types described herein may form complete garment structures and/or panels or components of garment structures having one or more additional components (e.g., garment components of the types described above in conjunction with FIGS. 1A-1F). Additionally or alternatively, garment components 500, 580, 700, 750, 800, and 900 of the types described herein may be joined with other garment components, including other garment components having inflatable bladder chambers. When joined with other garment components having inflatable bladder chambers, the garment component(s) 500, 580, 700, 750, 800, and 900 of the types described herein may be joined together and/or joined with other garment components having inflatable bladder chambers in a fluid communicating manner (i.e., so that fluid transfers between two or more garment components having inflatable bladder chambers that have been connected together). This may be accomplished in any suitable manner, including in any of the manners described in any of U.S. Provisional Patent Appln. Nos. 63/677,693, 63/677,708, 63/677,842, 63/677,870, 63/726,392, 63/726,394, 63/726,399, and 63/726,427.

While FIGS. 5A-9 illustrate garment components and garments having various different features, such as dome structures sizes, shapes, relative spacings, and specific configurations and/or many variations in features are possible without departing from this technology. The specifically illustrated garments, garment components, their bladders and bladder chamber portions, their dome structures, and/or other features could be varied widely in size, shape, configuration, and/or aesthetic appearance while still providing the desired functions and/or properties described above.

Garments that include dome structures 540 of the types described herein (e.g., with respect to FIGS. 5B, 5C, and 7A-9) may use at least some dome structures 540 on the interior of the garment to help hold some portions of the garment component off a wearer’s body. Such features can improve the “feel” of the garment on the wearer’s body, provide improved breathability, and/or improve air circulation.

For avoidance of doubt, this application includes within its scope at least the subject matter described in the following numbered “Clauses:”

Clause 1. A garment component, comprising: (A) a first laminate structure including: (i) a first fabric having a first inner face and a first outer face, and (ii) a first film including at least one fluid impervious layer chosen from a polyurethane layer and a thermoplastic polyurethane layer, wherein the first film is adhesively bonded to the first inner face of the first fabric; (B) a fluid impervious component including a sheet component having a thermoformed structure, the sheet component including an exterior surface and an interior surface located opposite the exterior surface, wherein the fluid impervious component is fixed with respect to the first film at a seam so as to form a fluid impervious chamber between the first film and the interior surface, wherein the thermoformed structure of the sheet component includes one or more thermoformed dome components extending outward from a base level of the sheet component; and (C) a fabric member located between the first film and the interior surface, wherein the fabric member includes a first surface facing the first film and a second surface facing the interior surface, wherein the second surface is bonded to the interior surface of the sheet component at the base level and unbonded to the sheet component at the one or more thermoformed dome components.

Clause 2. The garment component according to Clause 1, further comprising an adhesive provided between the second surface of the fabric member and the interior surface of the sheet component at locations where the second surface is bonded to the interior surface of the sheet component at the base level, wherein no adhesive is provided between the second surface of the fabric member and the interior surface of the sheet component at one or more locations corresponding to the one or more thermoformed dome components.

Clause 3. The garment component according to Clause 1, further comprising an adhesion blocker provided between the second surface of the fabric member and the interior surface of the sheet component at one or more locations corresponding to the one or more thermoformed dome components, wherein no adhesion blocker is provided between the second surface of the fabric member and the interior surface of the sheet component at locations where the second surface of the fabric member is bonded to the interior surface of the sheet component.

Clause 4. The garment component according to any one of Clauses 1 to 3, wherein the fluid impervious component comprises a second laminate structure including: (i) a second fabric having a second inner face and a second outer face, the second outer face forming the exterior surface of the fluid impervious component, and (ii) a second film including at least one fluid impervious layer chosen from a polyurethane layer and a thermoplastic polyurethane layer, wherein the second film is adhesively bonded to the second inner face of the second fabric, and wherein an interiormost surface of the second film forms the interior surface of the fluid impervious component.

Clause 5. The garment component according to any one of Clauses 1 to 4, wherein the first laminate structure has a thermoformed structure including one or more thermoformed dome components extending outward from a base level of the first laminate structure.

Clause 6. A method of making a garment component, comprising: (A) placing a first laminate structure in a mold cavity, the first laminate structure including: (i) a first fabric having a first inner face and a first outer face, and (ii) a first film including at least one fluid impervious layer chosen from a polyurethane layer and a thermoplastic polyurethane layer, wherein the first film is adhesively bonded to the first inner face of the first fabric, wherein a first surface of the mold cavity includes a first recess extending outward from a base level of the first surface of the mold cavity; (B) placing a fluid impervious component in the mold cavity, the fluid impervious component including a sheet component having an exterior surface and an interior surface located opposite the exterior surface, wherein the fluid impervious component is placed adjacent the first surface of the mold cavity such that the interior surface faces the first film; (C) placing a fabric member between the first film and the interior surface, wherein the fabric member is placed such that a first surface of the fabric member faces the first film and a second surface of the fabric member faces the interior surface; (D) providing an adhesive between interfacing surfaces of the second surface of the fabric member and the interior surface of the fluid impervious component, wherein the adhesive is provided such that a first area between the interfacing surfaces remains free of the adhesive, and wherein the first area is located adjacent the first recess; and (E) closing the mold cavity and thermoforming the fluid impervious component to form a first thermoformed dome component in the fluid impervious component at a location corresponding to the first area and the first recess.

Clause 7. A method of making a garment component, comprising: (A) placing a first laminate structure in a mold cavity, the first laminate structure including: (i) a first fabric having a first inner face and a first outer face, and (ii) a first film including at least one fluid impervious layer chosen from a polyurethane layer and a thermoplastic polyurethane layer, wherein the first film is adhesively bonded to the first inner face of the first fabric, wherein a first surface of the mold cavity includes a first recess extending outward from a base level of the first surface of the mold cavity; (B) placing a fluid impervious component in the mold cavity, the fluid impervious component including a sheet component having an exterior surface and an interior surface located opposite the exterior surface, wherein the fluid impervious component is placed adjacent the first surface of the mold cavity such that the interior surface faces the first film; (C) placing a fabric member between the first film and the interior surface, wherein the fabric member is placed such that a first surface of the fabric member faces the first film and a second surface of the fabric member faces the interior surface; (D) providing an adhesion blocker at a first area between interfacing surfaces of the second surface of the fabric member and the interior surface of the fluid impervious component, wherein the first area is located adjacent the first recess; and (E) closing the mold cavity and thermoforming the fluid impervious component to form a first thermoformed dome component in the fluid impervious component at a location corresponding to the first area and the first recess, wherein the interfacing surfaces of the second surface of the fabric member and the interior surface of the fluid impervious component bond together at locations around the first area.

Clause 8. The method according to Clause 6 or 7, wherein the fluid impervious component comprises a second laminate structure including: (i) a second fabric having a second inner face and a second outer face, the second outer face forming the exterior surface of the fluid impervious component, and (ii) a second film including at least one fluid impervious layer chosen from a polyurethane layer and a thermoplastic polyurethane layer, wherein the second film is adhesively bonded to the second inner face of the second fabric, and wherein an interiormost surface of the second film forms the interior surface of the fluid impervious component.

Clause 9. The method according to any one of Clauses 6 to 8, wherein a second surface of the mold cavity includes a second recess extending outward from a base level of the second surface of the mold cavity, wherein the second recess forms a thermoformed structure in the first laminate structure including one or more thermoformed dome components extending outward from a base level of the first laminate structure.

Clause 10. A garment component, comprising: (A) a first laminate structure including: (i) a first fabric having a first inner face and a first outer face, and (ii) a first film including at least one fluid impervious layer chosen from a polyurethane layer and a thermoplastic polyurethane layer, wherein the first film is adhesively bonded to the first inner face of the first fabric; (B) a fluid impervious component including a sheet component having an exterior surface and an interior surface located opposite the exterior surface, wherein the fluid impervious component is fixed with respect to the first film at a seam so as to form a fluid impervious chamber between the first film and the interior surface, wherein the sheet component includes one or more dome components extending outward from a base level of the sheet component; and (C) a fabric member located between the first film and the interior surface, wherein the fabric member includes a first surface facing the first film and a second surface facing the interior surface, wherein the second surface is bonded to the interior surface of the sheet component at the base level and unbonded to the sheet component at the one or more dome components.

Clause 11. The garment component according to Clause 10, further comprising an adhesive provided between the second surface of the fabric member and the interior surface of the sheet component at locations where the second surface is bonded to the interior surface of the sheet component at the base level, wherein no adhesive is provided between the second surface of the fabric member and the interior surface of the sheet component at one or more locations corresponding to the one or more dome components.

Clause 12. The garment component according to Clause 10, further comprising an adhesion blocker provided between the second surface of the fabric member and the interior surface of the sheet component at one or more locations corresponding to the one or more dome components, wherein no adhesion blocker is provided between the second surface of the fabric member and the interior surface of the sheet component at locations where the second surface of the fabric member is bonded to the interior surface of the sheet component.

Clause 13. The garment component according to any one of Clauses 10 to 12, wherein the fluid impervious component comprises a second laminate structure including: (i) a second fabric having a second inner face and a second outer face, the second outer face forming the exterior surface of the fluid impervious component, and (ii) a second film including at least one fluid impervious layer chosen from a polyurethane layer and a thermoplastic polyurethane layer, wherein the second film is adhesively bonded to the second inner face of the second fabric, and wherein an interiormost surface of the second film forms the interior surface of the fluid impervious component.

Clause 14. The garment component according to any one of Clauses 10 to 13, wherein the first laminate structure includes one or more dome components extending outward from a base level of the first laminate structure.

Clause 15. A method of making a garment component, comprising: (A) placing a first laminate structure in a mold cavity, the first laminate structure including: (i) a first fabric having a first inner face and a first outer face, and (ii) a first film including at least one fluid impervious layer chosen from a polyurethane layer and a thermoplastic polyurethane layer, wherein the first film is adhesively bonded to the first inner face of the first fabric, wherein a first surface of the mold cavity includes a first recess extending outward from a base level of the first surface of the mold cavity; (B) placing a fluid impervious component in the mold cavity, the fluid impervious component including a sheet component having an exterior surface and an interior surface located opposite the exterior surface, wherein the fluid impervious component is placed adjacent the first surface of the mold cavity such that the interior surface faces the first film; (C) placing a fabric member between the first film and the interior surface, wherein the fabric member is placed such that a first surface of the fabric member faces the first film and a second surface of the fabric member faces the interior surface; (D) providing an adhesive between interfacing surfaces of the second surface of the fabric member and the interior surface of the fluid impervious component, wherein the adhesive is provided such that a first area between the interfacing surfaces remains free of the adhesive, and wherein the first area is located adjacent the first recess; and (E) closing the mold cavity and shaping the fluid impervious component to form a first dome component in the fluid impervious component at a location corresponding to the first area and the first recess.

Clause 16. A method of making a garment component, comprising: (A) placing a first laminate structure in a mold cavity, the first laminate structure including: (i) a first fabric having a first inner face and a first outer face, and (ii) a first film including at least one fluid impervious layer chosen from a polyurethane layer and a thermoplastic polyurethane layer, wherein the first film is adhesively bonded to the first inner face of the first fabric, wherein a first surface of the mold cavity includes a first recess extending outward from a base level of the first surface of the mold cavity; (B) placing a fluid impervious component in the mold cavity, the fluid impervious component including a sheet component having an exterior surface and an interior surface located opposite the exterior surface, wherein the fluid impervious component is placed adjacent the first surface of the mold cavity such that the interior surface faces the first film; (C) placing a fabric member between the first film and the interior surface, wherein the fabric member is placed such that a first surface of the fabric member faces the first film and a second surface of the fabric member faces the interior surface; (D) providing an adhesion blocker at a first area between interfacing surfaces of the second surface of the fabric member and the interior surface of the fluid impervious component, wherein the first area is located adjacent the first recess; and (E) closing the mold cavity and shaping the fluid impervious component to form a first dome component in the fluid impervious component at a location corresponding to the first area and the first recess, wherein the interfacing surfaces of the second surface of the fabric member and the interior surface of the fluid impervious component bond together at locations around the first area.

Clause 17. The method according to Clause 15 or 16, wherein the fluid impervious component comprises a second laminate structure including: (i) a second fabric having a second inner face and a second outer face, the second outer face forming the exterior surface of the fluid impervious component, and (ii) a second film including at least one fluid impervious layer chosen from a polyurethane layer and a thermoplastic polyurethane layer, wherein the second film is adhesively bonded to the second inner face of the second fabric, and wherein an interiormost surface of the second film forms the interior surface of the fluid impervious component.

Clause 18. The method according to any one of Clauses 15 to 17, wherein a second surface of the mold cavity includes a second recess extending outward from a base level of the second surface of the mold cavity, wherein the second recess forms a structure in the first laminate structure including one or more dome components extending outward from a base level of the first laminate structure.

### II. Conclusion

The present invention is disclosed above and in the accompanying drawings with reference to a variety of example structures. The purpose served by the disclosure, however, is to provide examples of the various features and concepts related to the invention, not to limit the scope of the invention. One skilled in the relevant art will recognize that numerous variations and modifications may be made to the embodiments described above without departing from the scope of the present invention, as defined by the appended claims.

1. A garment component, comprising:
a first laminate structure including: (i) a first fabric having a first inner face and a first outer face, and (ii) a first film including at least one fluid impervious layer chosen from a polyurethane layer and a thermoplastic polyurethane layer, wherein the first film is adhesively bonded to the first inner face of the first fabric;
a fluid impervious component including a sheet component having a thermoformed structure, the sheet component including an exterior surface and an interior surface located opposite the exterior surface, wherein the fluid impervious component is fixed with respect to the first film at a seam so as to form a fluid impervious chamber between the first film and the interior surface, wherein the thermoformed structure of the sheet component includes one or more thermoformed dome components extending outward from a base level of the sheet component; and
a fabric member located between the first film and the interior surface, wherein the fabric member includes a first surface facing the first film and a second surface facing the interior surface, wherein the second surface is bonded to the interior surface of the sheet component at the base level and unbonded to the sheet component at the one or more thermoformed dome components.

2. The garment component according to claim 1, further comprising an adhesive provided between the second surface of the fabric member and the interior surface of the sheet component at locations where the second surface is bonded to the interior surface of the sheet component at the base level, wherein no adhesive is provided between the second surface of the fabric member and the interior surface of the sheet component at one or more locations corresponding to the one or more thermoformed dome components.

3. The garment component according to claim 1, further comprising an adhesion blocker provided between the second surface of the fabric member and the interior surface of the sheet component at one or more locations corresponding to the one or more thermoformed dome components, wherein no adhesion blocker is provided between the second surface of the fabric member and the interior surface of the sheet component at locations where the second surface of the fabric member is bonded to the interior surface of the sheet component.

4. The garment component according to claim 1, wherein the fluid impervious component comprises a second laminate structure including: (i) a second fabric having a second inner face and a second outer face, the second outer face forming the exterior surface of the fluid impervious component, and (ii) a second film including at least one fluid impervious layer chosen from a polyurethane layer and a thermoplastic polyurethane layer, wherein the second film is adhesively bonded to the second inner face of the second fabric, and wherein an interiormost surface of the second film forms the interior surface of the fluid impervious component.

5. The garment component according to claim 1, wherein the first laminate structure has a thermoformed structure including one or more thermoformed dome components extending outward from a base level of the first laminate structure.

6. A garment component, comprising:
a first laminate structure including: (i) a first fabric having a first inner face and a first outer face, and (ii) a first film including at least one fluid impervious layer chosen from a polyurethane layer and a thermoplastic polyurethane layer, wherein the first film is adhesively bonded to the first inner face of the first fabric;
a fluid impervious component including a sheet component having an exterior surface and an interior surface located opposite the exterior surface, wherein the fluid impervious component is fixed with respect to the first film at a seam so as to form a fluid impervious chamber between the first film and the interior surface, wherein the sheet component includes one or more dome components extending outward from a base level of the sheet component; and
a fabric member located between the first film and the interior surface, wherein the fabric member includes a first surface facing the first film and a second surface facing the interior surface, wherein the second surface is bonded to the interior surface of the sheet component at the base level and unbonded to the sheet component at the one or more dome components.

7. The garment component according to claim 6, further comprising an adhesive provided between the second surface of the fabric member and the interior surface of the sheet component at locations where the second surface is bonded to the interior surface of the sheet component at the base level, wherein no adhesive is provided between the second surface of the fabric member and the interior surface of the sheet component at one or more locations corresponding to the one or more dome components.

8. The garment component according to claim 6, further comprising an adhesion blocker provided between the second surface of the fabric member and the interior surface of the sheet component at one or more locations corresponding to the one or more dome components, wherein no adhesion blocker is provided between the second surface of the fabric member and the interior surface of the sheet component at locations where the second surface of the fabric member is bonded to the interior surface of the sheet component.

9. The garment component according to claim 6, wherein the fluid impervious component comprises a second laminate structure including: (i) a second fabric having a second inner face and a second outer face, the second outer face forming the exterior surface of the fluid impervious component, and (ii) a second film including at least one fluid impervious layer chosen from a polyurethane layer and a thermoplastic polyurethane layer, wherein the second film is adhesively bonded to the second inner face of the second fabric, and wherein an interiormost surface of the second film forms the interior surface of the fluid impervious component.

10. The garment component according to claim 6, wherein the first laminate structure includes one or more dome components extending outward from a base level of the first laminate structure.

11. A method of making a garment component, comprising:
placing a first laminate structure in a mold cavity, the first laminate structure including: (i) a first fabric having a first inner face and a first outer face, and (ii) a first film including at least one fluid impervious layer chosen from a polyurethane layer and a thermoplastic polyurethane layer, wherein the first film is adhesively bonded to the first inner face of the first fabric, wherein a first surface of the mold cavity includes a first recess extending outward from a base level of the first surface of the mold cavity;
placing a fluid impervious component in the mold cavity, the fluid impervious component including a sheet component having an exterior surface and an interior surface located opposite the exterior surface, wherein the fluid impervious component is placed adjacent the first surface of the mold cavity such that the interior surface faces the first film;
placing a fabric member between the first film and the interior surface, wherein the fabric member is placed such that a first surface of the fabric member faces the first film and a second surface of the fabric member faces the interior surface;
at least one of: (A) providing an adhesive between interfacing surfaces of the second surface of the fabric member and the interior surface of the fluid impervious component, wherein the adhesive is provided such that a first area between the interfacing surfaces remains free of the adhesive, and wherein the first area is located adjacent the first recess, and/or (B) providing an adhesion blocker at the first area; and
closing the mold cavity and shaping the fluid impervious component to form a first dome component in the fluid impervious component at a location corresponding to the first area and the first recess.

12. The method according to claim 11, wherein the method includes providing the adhesive between the interfacing surfaces.

13. The method according to claim 12, wherein the shaping the fluid impervious component to form the first dome component includes thermoforming the fluid impervious component.

14. The method according to claim 12, wherein the method additionally includes providing the adhesion blocker at the first area.

15. The method according to claim 14, wherein the shaping the fluid impervious component to form the first dome component includes thermoforming the fluid impervious component.

16. The method according to claim 11, wherein the method includes providing the adhesion blocker at the first area.

17. The method according to claim 16, wherein the shaping the fluid impervious component to form the first dome component includes thermoforming the fluid impervious component.

18. The method according to claim 11, wherein the fluid impervious component comprises a second laminate structure including: (i) a second fabric having a second inner face and a second outer face, the second outer face forming the exterior surface of the fluid impervious component, and (ii) a second film including at least one fluid impervious layer chosen from a polyurethane layer and a thermoplastic polyurethane layer, wherein the second film is adhesively bonded to the second inner face of the second fabric, and wherein an interiormost surface of the second film forms the interior surface of the fluid impervious component.

19. The method according to claim 11, wherein a second surface of the mold cavity includes a second recess extending outward from a base level of the second surface of the mold cavity, wherein the second recess forms a structure in the first laminate structure including one or more dome components extending outward from a base level of the first laminate structure.

20. The method according to claim 11, wherein the shaping the fluid impervious component to form the first dome component includes thermoforming the fluid impervious component.
